(19) United States
(12) Patent Application Publication
(10) Pub. No.: US 2023/0291533 A1
(43) Pub. Date: Sep. 14, 2023

(54) JOINT DL/UL TCI STATE ACTIVATION

(71) Applicant: QUALCOMM Incorporated, San Diego, CA (US)

(72) Inventors: Yan ZHOU, San Diego, CA (US); Fang YUAN, Beijing (CN); Tao LUO, San Diego, CA (US)

(21) Appl. No.: 18/018,503

(22) PCT Filed: Sep. 8, 2021
(86) PCT No.: PCT/CN2021/117102

§ 371 Date: Jan. 27, 2023

(30) Foreign Application Priority Data
Sep. 9, 2020 (WO) PCT/CN2020/114220
Sep. 9, 2020 (WO) PCT/CN2020/114233

(51) Int. Cl. H04L 5/00; H04B 7/08; H04B 7/06

(52) U.S. Cl. CPC H04L 5/0098; H04L 5/001; H04B 7/088; H04B 7/0695

(57) ABSTRACT

Aspects of the present disclosure relate to cross-component carrier (CC) activation of joint downlink (DL)/uplink (UL) transmission configuration indicator (TCI) states. In one aspect, the apparatus receives, from a base station, an activation of a joint DL and UL TCI state for a CC, the joint DL and UL TCI state indicating a common beam for communication in DL and UL. The apparatus applies the joint DL and UL TCI state to multiple CCs in response to receiving the activation of the joint DL and UL TCI state for the CC.

### CROSS REFERENCE TO RELATED APPLICATION(S)

This application claims the benefit of and priority to International Patent Application No. PCT/CN2020/114220, entitled “METHODS AND APPARATUS FOR ACTIVATION OF JOINT DL/UL TCI STATES” and filed on Sep. 9, 2020, and International Patent Application No. PCT/CN2020/114233, entitled “CROSS-COMPONENT CARRIER ACTIVATION OF JOINT DL/UL TCI STATE” and filed on Sep. 9, 2020, each of which is expressly incorporated by reference herein in its entirety.

### TECHNICAL FIELD

The present disclosure relates generally to communication systems, and more particularly, to cross-component carrier (CC) activation of joint downlink (DL)/uplink (UL) transmission configuration indicator (TCI) states.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a base station. The device may be a processor and/or a modem at a base station or the base station itself. The apparatus configures a CC list comprising multiple CCs. The apparatus may transmit, to a user equipment (UE), an activation of a joint DL and UL TCI state for a CC comprised in the CC list to activate the joint DL and UL TCI state for each of the multiple CCs comprised in the list, where the joint DL and UL TCI state indicates a common beam for communication in DL and UL. The base station may transmit a medium access control (MAC) control element (CE) (MAC-CE) to a UE, the MAC-CE activating a subset of configured joint DL and UL TCI states, each activated joint DL and UL TCI state indicating a common beam for communication in DL and UL. The base station may transmit a configuration indicating applicable DL/UL types of resources for activated joint DL/UL TCI states to the UE. The applicable DL/UL types of resources may include one or more of a physical downlink control channel (PDCCH), a physical downlink shared channel (PDSCH), a channel state information (CSI) reference signals (RS) (CSI-RS), or a positioning RS (PRS) for the DL, and one or more of a physical uplink control channel (PUCCH), a physical uplink shared channel (PUSCH), sounding reference signals (SRS), or a physical random access channel (PRACH) for the UL. The configuration may be received through at least one of a radio resource control (RRC) signaling, a MAC-CE, and/or control information (DCI). The base station may transmit a DCI indicating an index of a TCI codepoint, the index corresponding to one of the activated joint DL and UL TCI states to the UE.

The apparatus may be a device at a UE. The device may be a processor and/or a modem at a UE or the UE itself. The apparatus receives, from a base station, an activation of a joint DL and UL TCI state for a CC, the joint DL and UL TCI state indicating a common beam for communication of data and control channels in DL and UL. The apparatus applies the joint DL and UL TCI state to multiple CCs in response to receiving the activation of the joint DL and UL TCI state for the CC. The UE may transmit an acknowledgment to the base station confirming reception of the DCI indicating the TCI state. The base station may transmit an indication of the DL resources and the UL resources for the communication to the UE. The indication may be received through one of the RRC signaling, the MAC-CE, or the DCI. The UE may determine DL resources and UL resources for the communication to which the one activated joint DL and UL TCI state corresponding to the index of the TCI codepoint indicated through the DCI applies. The DL resources and the UL resources for the communication may be determined based on a predefined rule or the indication received. The UE and the base station may communicate with each other through DL and UL based on the activated joint DL and UL TCI states.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is an example of a MAC-CE of wireless communication.

FIG. 5 is a call flow diagram of wireless communication.

FIG. 6 is a flowchart of a method of wireless communication.

FIG. 7 is a flowchart of a method of wireless communication.

FIG. 8 is a flowchart of a method of wireless communication.

FIG. 9 is a flowchart of a method of wireless communication.

FIG. 10A is a diagram illustrating a MAC-CE for activating joint DL/UL TCI states.

FIG. 10B is a diagram illustrating a configured CC list for cross-CC activation.

FIG. 11 is a call flow diagram of signaling between a UE and a base station.

FIG. 12 is a flowchart of a method of wireless communication.

FIG. 13 is a flowchart of a method of wireless communication.

FIG. 14 is a flowchart of a method of wireless communication.

FIG. 15 is a flowchart of a method of wireless communication.

FIG. 16 is a diagram illustrating an example of a hardware implementation for an example apparatus.

FIG. 17 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

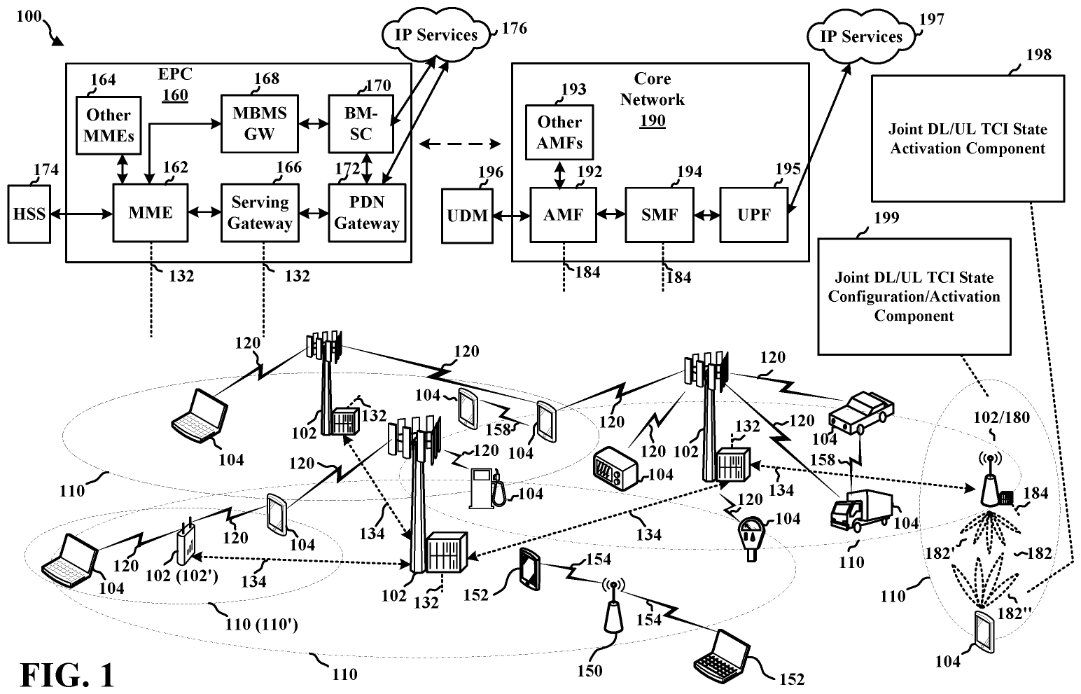

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., 51 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a joint DL/UL TCI state activation component 198 configured to receive a MAC-CE activating the joint DL/UL TCI states, process the received MAC-CE activating the joint DL/UL TCI states, and communicate with the base station through DL and UL based on the activated joint DL/UL TCI states. In certain aspects, the base station 180 may include a joint DL/UL TCI state configuration/activation component 199 configured to transmit the MAC-CE activating the joint DL/UL TCI states to the UE, and communicate with the base station through DL and UL based on the activated joint DL/UL TCI states. Although the following description may be focused on 5G NR, the concepts described herein may be applicable to other similar areas, such as LTE, LTE-A, CDMA, GSM, and other wireless technologies.

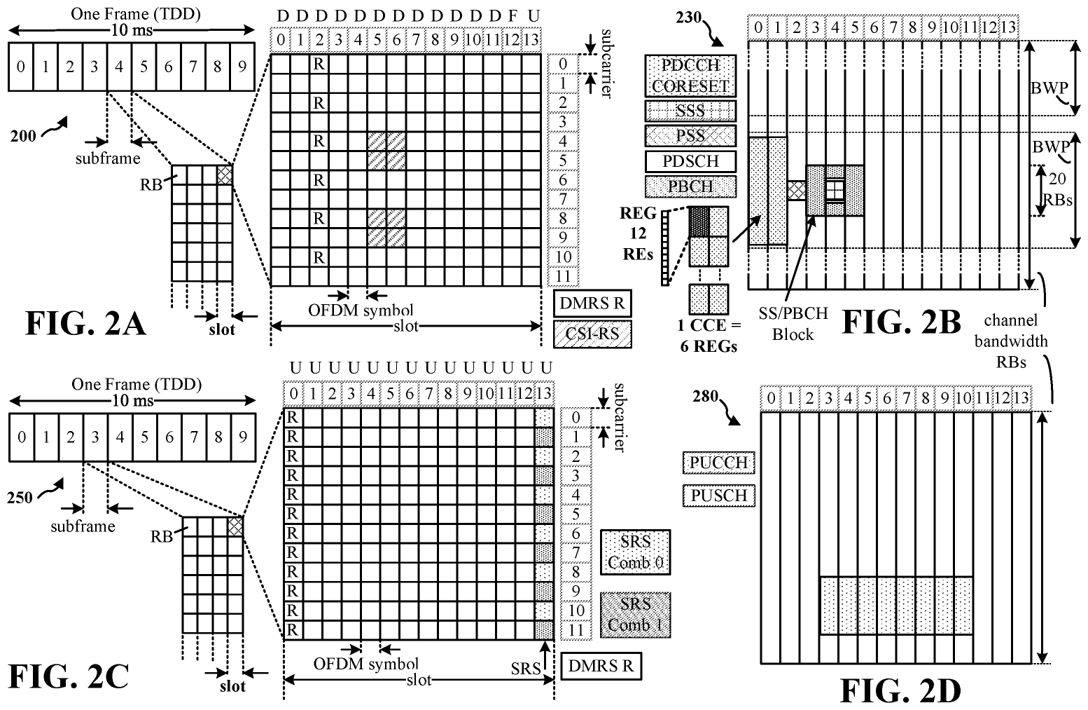

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ} * 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

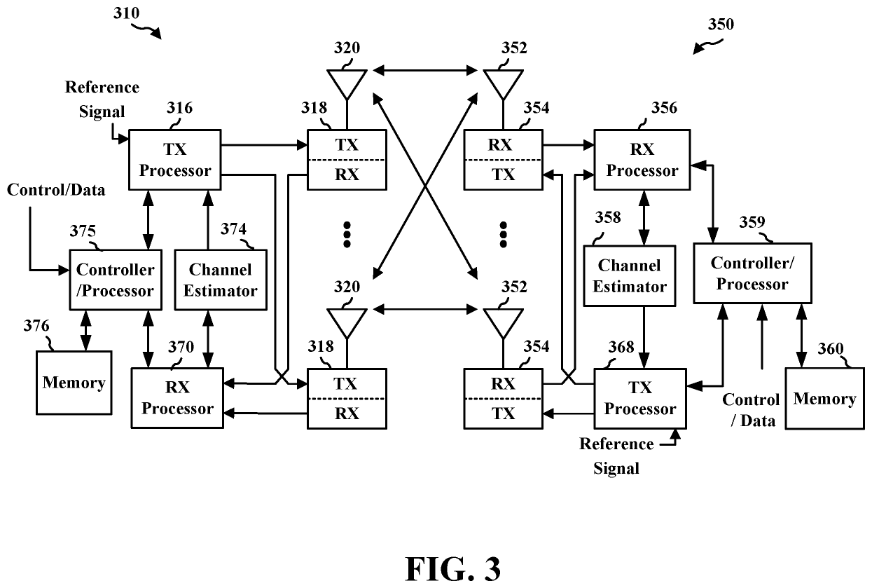

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1. At least one of the TX processor 316, the RX processor 370, and the controller/processor 375 may be configured to perform aspects in connection with 199 of FIG. 1.

In some aspects of wireless communication, it may be beneficial to include an enhancement on multi-beam operation, mainly targeting frequency range 2 (FR2) while also applicable to frequency range 1 (FR1). To enhance multi-beam operation, features may be identified and specified to facilitate a more efficient (lower latency and overhead) DL/UL beam management to support higher intra-cell mobility and layer 1 (L1)/layer 2 (L2)-centric inter-cell mobility and/or a larger number of configured TCI states. A common beam for data and control transmission/reception for DL and UL, especially for intra-band carrier aggregation (CA), may be specified in order to provide a unified TCI framework for DL and UL beam indication. Enhancement on signaling mechanisms for the above features to improve latency and efficiency with more usage of dynamic control signaling (as opposed to RRC) may be provided. Further, features may be identified and specified to facilitate UL beam selection for UEs equipped with multiple panels, considering UL coverage loss mitigation due to a maximum permissible exposure (MPE), based on an UL beam indication with the unified TCI framework for an UL fast panel selection.

In some aspects, a unified TCI framework for DL and UL beam indication may be beneficial. A major use case may be to signal a common beam for multiple DL and UL resources to save both beam indication and overhead latency. The common beam indication may be signaled via a joint DL/UL TCI state. The activation of the joint DL/UL TCI state using a MAC-CE is described infra.

A joint DL/UL TCI state may jointly indicate a common beam or a set of common beams applied commonly to each of multiple DL/UL resources and may include a set of information.

In one aspect, each of the joint DL/UL TCI states may include a TCI state identification (ID). The TCI state ID may be in a dedicated ID space for common beam(s) indication, or in a common ID space shared for common DL/UL beam(s) indication, a DL beam indication, and/or an UL beam indication.

In another aspect, the joint DL/UL TCI state may include IDs of one or more source reference signals (RSs), providing at least one DL quasi-co-location (QCL) assumption and/or UL spatial relation information. The one or more source RSs may include a serving cell ID and a BWP ID where the one or more source RSs are located. If the serving cell ID is absent, the serving cell in which the TCI state is configured is selected.

The one or more source RSs may include various RS types, including a synchronization signal block (SSB), CSI-RS, a PRS, a PRACH, dedicated demodulation reference signals (DM-RS) of a PDSCH, a PDCCH, a PUCCH, or a PUSCH.

The one or more source RSs may provide various QCL assumptions and/or spatial relation information, including characteristics on delay, Doppler, and/or spatial Rx/Tx parameters. For example, the QCL may include a QCL-typeA including a Doppler shift, a Doppler spread, an average delay, and a delay spread, a QCL-typeB including the Doppler shift and the Doppler spread, a QCL-typeC including the Doppler shift and the average delay, and a QCL-typeD including a spatial Rx parameter.

The one or more source RSs may have different combinations based on provided QCL/spatial assumptions. For example, the joint DL/UL TCI state may include an ID of one source RS for QCL-TypeA/B/C. For another example, three source RSs including a first RS for QCL-Type AB/C, a second RS for QCL-Type D, and a third RS for spatial relation information.

In another aspect, each of the joint DL/UL TCI states may include UL power control (PC) parameters indicating the UE to configure the UL transmission power. The one or more power control parameters may include a pathloss reference signal (such as a CSI-RS or other reference signal), a nominal power parameter (such a PO or other nominal power), a pathloss scaling factor (such as a or other scaling factor), a close-loop index, an identifier of a power control group (such as a PC group ID), or a combination thereof.

In another aspect, each of the joint DL/UL TCI states may include UL timing advance (TA) parameters indicating the UE to configure the TA for the UL transmission. The one or more TA parameters may include a TA value, an identifier of a TA group (such as a TA group ID), or a combination thereof.

In another aspect, each of the joint DL/UL TCI states may include one or more parameters for codebook and/or non-codebook based PUSCH transmission. The one or more codebook or non-codebook parameters may include an SRS resource indicator (SRI); a precoding matrix indicator (PMI), such as a transmission PMI (TPMI); a rank indicator (RI), such as a transmission rank indicator (TRI); or a combination thereof.

In yet another aspect, each of the joint DL/UL TCI states may include UE panel IDs or similar IDs. For example, the UE panel ID(s) associated with the common DL/UL beam may include two separate panel IDs for DL and UL or a single panel ID for both DL and UL.

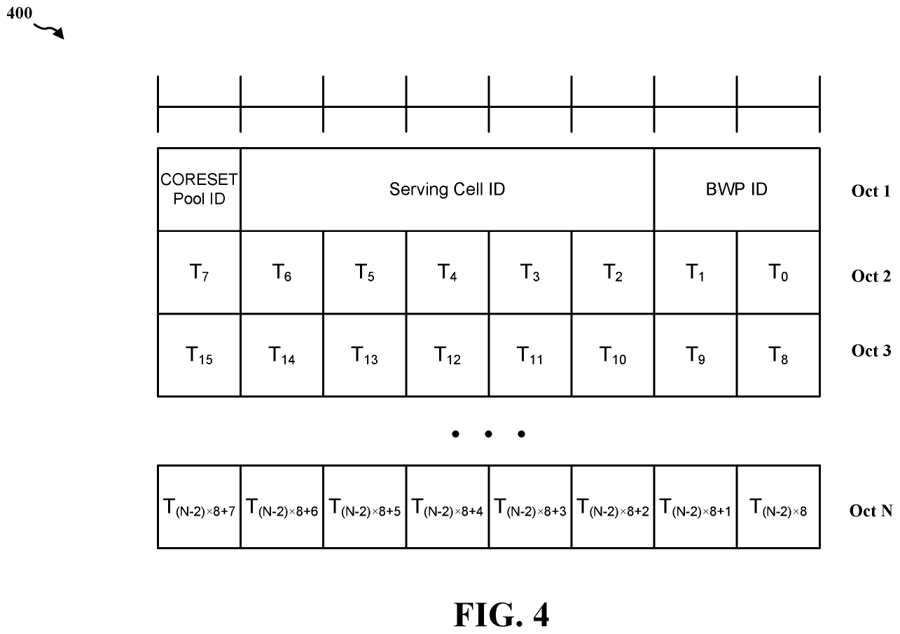

FIG. 4 is an example of MAC-CE 400 of wireless communication. For a single TRP case, a base station may provide a MAC-CE to a UE to activate one or more configured joint DL/UL TCI states. In some aspects, the DCI and/or MAC-CE may activate subsets of configured joint DL/UL TCI states, where each joint DL/UL TCI state may indicate a common beam for DL reception/UL transmission. That is, a set of joint DL/UL states may be configured, and the base station may transmit a MAC-CE to the UE to indicate the UE to activate one or more subsets of the configured joint DL/UL TCI states.

The activation MAC-CE 400 may include a bitmap indicating which configured joint DL/UL TCI state(s) are activated, and a serving cell ID and/or a BWP ID for which the activation MAC-CE 400 applies. The MAC-CE 400 may include a variable size bitmap including any of a CORESET pool ID, a serving cell ID field, a BWP ID field, and TCI state fields. For example, a first octet (Oct) of the MAC-CE bitmap may include any of the CORESET pool ID, the serving cell ID, and the BWP ID.

The CORESET pool ID may indicate whether a mapping between the activated TCI states and a codepoint of the DCI is preconfigured or based on a preconfigured rule. For example, the length of the CORESET pool ID may be 1 bit. The serving cell ID may indicate the identity of the serving cell for which the MAC-CE 400 applies. For example, the length of the serving cell ID field may be 5 bits. The BWP ID may indicate a DL BWP for which the MAC-CE 400 applies as the codepoint. For example, the length of the BWP ID field may be 2 bits.

The remaining octets may be a bitmap of the joint DL/UL TCI states, each bit corresponding to each joint DL/UL TCI state. If a bit is set to 1, then the corresponding joint DL/UL TCI state may be activated. For example, the base station may configure up to 128 joint DL/UL TCI states, and the bitmap may have a bit length of 128 bits. The MAC-CE 400 may select up to 8 bits, and therefore, the bitmap may have up to 8 bits set to 1 to activate the corresponding joint DL/UL TCI state.

The activated joint DL/UL TCI state(s) may be applied to the following DL reception/UL transmission types or resources. That is, the activated joint DL/UL TCI states may indicate one or more DL reception/UL transmission types or resources to which the activated joint DL/UL TCI states may be applied. For example, the DL reception type or resource may include a PDCCH, a PDSCH, CSI-RS, PRS, and/or a SSB, and the UL transmission type or resource may include a PUCCH, a PUSCH, SRS, and/or a PRACH. The applicable DL reception/UL transmission type/resource per activated joint DL/UL TCI state may be determined via various options. In one aspect, the applicable DL reception/UL transmission types/resources may be described in a specification (i.e., predetermined). For example, it may be predetermined that the activated joint DL/UL TCI state can be applied to all DL receptions and UL transmissions types/resources in a component carrier (CC) where the MAC-CE is applied.

In one aspect, the applicable DL reception/UL transmission types and/or resources may be configured or indicated by the base station, for example, via RRC/MAC-CE/DCI. For example, the base station may indicate that one activated joint DL/UL TCI state can be applied to all PDCCH, PUCCH, and SRS in the CC where the MAC-CE is applied.

In some aspects, if multiple joint DL/UL TCI states can be activated by the MAC-CE, a DCI may further indicate a TCI codepoint mapped to one activated joint DL/UL TCI state. That is, a TCI codepoint field in DCI may include TCI codepoint indexes, respectively mapped to the activated joint DL/UL TCI states. The base station may transmit a DCI of a TCI codepoint field to the UE, including a TCI codepoint index mapped to an activated joint DL/UL TCI state among the activated multiple joint DL/UL TCI states.

The DCI carrying the TCI codepoint may or may not schedule any DL reception/UL transmission. At least for DCI not scheduling any DL reception/UL transmission, an acknowledgement (ACK) may be sent by the UE to confirm the reception of the DCI. That is, the UE may miss the transmission of the DCI carrying the TCI codepoint (or an index of the TCI codepoint), and therefore, to confirm the successful transmission of the DCI, the UE may send an information of acknowledgment back to the base station, in case the DCI does not schedule any DL/UL transmission.

The indicated TCI codepoint may be used for DL reception/UL transmission scheduled by the DCI carrying the TCI codepoint (or an index of the TCI codepoint), or the applicable DL reception/UL transmission may be indicated in a specification or by the base station, e.g., via RRC/MAC-CE/DCI. That is, in case the DCI indicating the TCI codepoint also schedules the DL/UL transmission, the TCI codepoint indicated by the DCI may be applied to that DL/UL transmission scheduled by the DCI. For example, the DCI scheduling PDSCH may also indicate a TCI codepoint mapped to one activated joint DL/UL TCI state for both the scheduled PDSCH and a corresponding PUCCH for ACK/NACK. That is, in case the DCI indicating the TCI codepoint also schedules the PDSCH for a DL transmission, the TCI codepoint indicated by the DCI may be applied to the PDSCH and the corresponding PUCCH. For example, the DCI can indicate TCI codepoint mapped to one activated joint DL/UL TCI state for all UE specific DL receptions/UL transmissions. That is, in case a rule is predefined that applicable DL/UL TCI states correspond to all UE specific DL reception/UL transmission, then the activated joint DL/UL TCI state may be applicable for all the UE specified DL reception/UL transmission.

In case of a TCI codepoint carried in a DCI, the activated joint DL/UL TCI state(s) by a MAC-CE may be sequentially mapped to candidate TCI codepoint(s) to be indicated in DCI. That is, the TCI states activated by the MAC-CE may be sequentially mapped to each bit of the TCI codepoints associated with the indexes of the TCI codepoints. For example, the MAC-CE may activate joint DL/UL TCI state ID #5, 7, 9, which sequentially maps to candidate TCI codepoints with values of 0, 1, 2. That is, the MAC-CE 400 may activate joint DL/UL TCI state T₅, T₇, and T₉, and they may be sequentially mapped to bits of TCI codepoints associated with the index 0, 1, and 2 of the TCI codepoints.

In some aspects, in the presence of DL TCI states, UL TCI states, and joint DL/UL TCI states, the MAC-CE activation of any configured TCI states may have various options.

For the TCI state ID space, separate TCI state ID spaces may be the DL TCI states, the UL TCI states, and the joint DL/UL TCI states, respectively. A common TCI state ID space may be at least for two of the DL TCI states, the UL TCI states, and the joint DL/UL TCI states, or all of them.

For the activation MAC-CE, separate MAC-CEs may be applied to activate the DL TCI states, the UL TCI states, and the joint DL/UL TCI states, respectively. Separate MAC-CEs for the DL TCI states, the UL TCI states, and the joint DL/UL TCI states may work with separate TCI state ID spaces, respectively, for the DL TCI states, the UL TCI states, and the joint DL/UL TCI states. A common MAC-CE may be at least for two of the DL TCI states, the UL TCI states, and the joint DL/UL TCI states, or all of them. The common MAC-CE may work with separate TCI state ID spaces respectively for the DL TCI states, the UL TCI states, and the joint DL/UL TCI states or with the common TCI state ID space for the DL TCI states, the UL TCI states, and the joint DL/UL TCI states. In the case of the common MAC-CE with separate TCI state ID spaces for the at least for two of the DL TCI states, the UL TCI states, and the joint DL/UL TCI states, the MAC-CE may utilize an indicator to indicate the type of TCI states (i.e., the DL TCI state, the UL TCI state, or the joint DL/UL TCI state) and, accordingly, the activated TCI state ID may refer to the ID space for the type of TCI states indicated by the indicator.

Furthermore, a number of subsets of the set of TCI states may respectively be for the DL TCI states, the UL TCI states, and the joint DL/UL TCI states. That is, a first subset of the set of TCI states may be the DL TCI states, a second subset of the set of TCI states may be the UL TCI states, and a third subset of the set of TCI states may be the DL/UL TCI states.

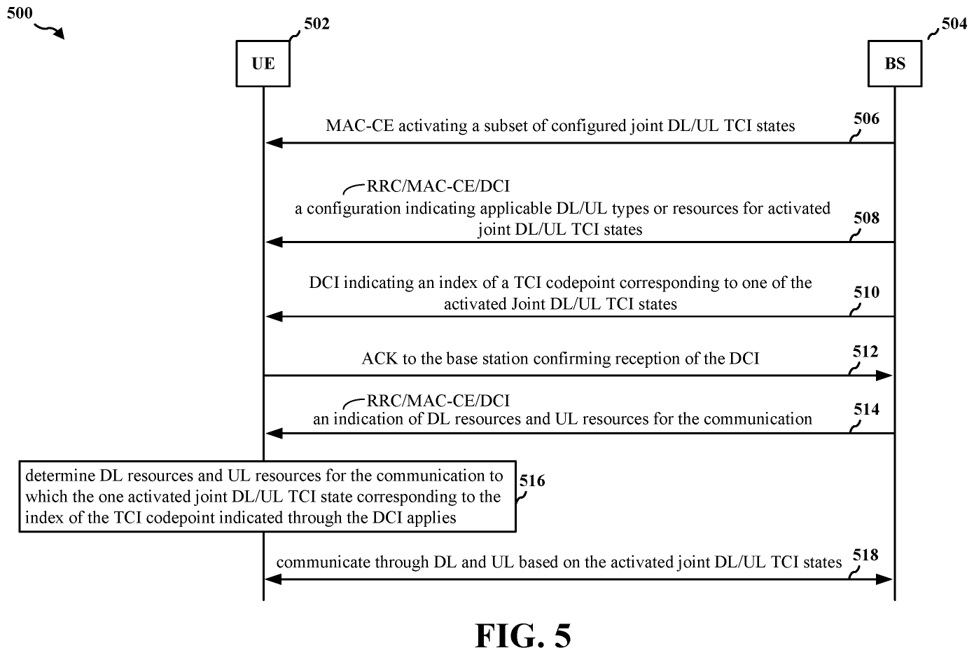

FIG. 5 is a call flow diagram 500 of wireless communication including a UE 502 and a base station 504. The base station 504 may signal a common beam indication to the UE 502 via a joint DL/UL TCI state, and activate the joint DL/UL TCI state using a MAC-CE. The UE 502 may receive, from the base station 504, a configuration of the common beam indication via the joint DL/UL TCI state and the activation of the joint DL/UL TCI state via the MAC-CE.

At 506, the base station 504 may transmit a MAC-CE to the UE 502, the MAC-CE activating a subset of configured joint DL and UL TCI states, each activated joint DL and UL TCI state indicating a common beam for communication in DL and UL. The UE 502 may receive a MAC-CE from the base station 504, the MAC-CE activating a subset of configured joint DL and UL TCI states, each activated joint DL and UL TCI state indicating a common beam for communication in DL and UL.

At 508, the base station 504 may transmit a configuration indicating applicable DL/UL types or resources for activated joint DL/UL TCI states to the UE 502. The UE 502 may receive a configuration indicating applicable DL/UL types or resources for activated joint DL/UL TCI states from the base station 504. The applicable DL/UL types or resources may include one or more of the PDCCH, the PDSCH, the CSI-RS, or the PRS for the DL, and one or more of the PUCCH, the PUSCH, the SRS, or the PRACH for the UL. The configuration may be received through at least one of the RRC signaling, the MAC-CE, and/or the DCI.

At 510, the base station 504 may transmit a DCI indicating an index of a TCI codepoint, the index corresponding to one of the activated joint DL and UL TCI states to the UE 502. The UE 502 may receive a DCI indicating an index of a TCI codepoint, the index corresponding to one of the activated joint DL and UL TCI states from the base station 504.

At 512, the UE 502 may transmit an acknowledgment (ACK) to the base station 504 confirming reception of the DCI. The base station 504 may receive, from the UE 502, the acknowledgement confirming the reception of the DCI.

At 514, the base station 504 may transmit an indication of the DL resources and the UL resources for the communication to the UE 502. The UE 502 may receive an indication of the DL resources and the UL resources for the communication from the base station 504. The indication may be received through one of the RRC signaling, the MAC-CE, or the DCI.

At 516, the UE 502 may determine DL resources and UL resources for the communication to which the one activated joint DL and UL TCI state corresponding to the index of the TCI codepoint indicated through the DCI applies. The DL resources and the UL resources for the communication may be determined based on a predefined rule or the indication received at 514.

At 518, the UE 502 and the base station 504 may communicate with each other through DL and UL based on the activated joint DL and UL TCI states.

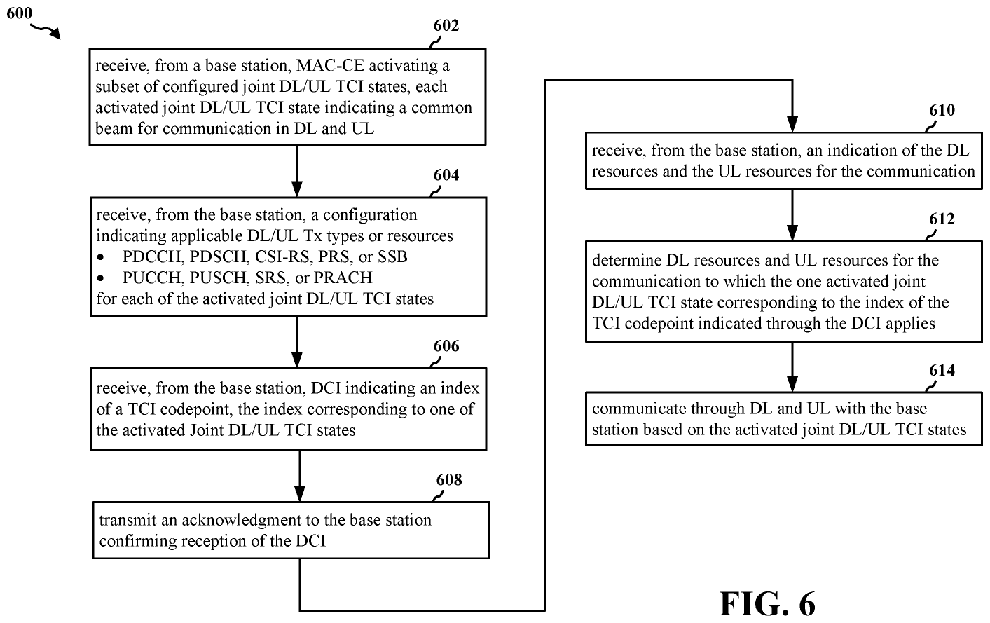

FIG. 6 is a flowchart 600 of a method of wireless communication. The method may be performed by a UE (e.g., the UE 104/502; the apparatus 1602). The UE may receive, from a base station, a configuration of the common beam indication via the joint DL/UL TCI state and the activation of the joint DL/UL TCI state via the MAC-CE.

At 602, the UE may receive, from a base station, a MAC-CE activating a subset of configured joint DL and UL TCI states, each activated joint DL and UL TCI state indicating a common beam for communication in DL and UL (e.g., as at 506). The MAC-CE may include a bitmap indicating which configured joint DL and UL TCI states are activated, and at least one of a serving cell ID associated with the base station or a BWP ID for which the activation applies. Each activated joint DL and UL TCI state may be associated with at least one of a PDCCH, a PDSCH, CSI-RS, PRS, or a SSB for DL, and at least one of a PUCCH, a PUSCH, SRS, or a PRACH for UL. The joint DL and UL TCI states activated in the MAC-CE may be mapped with sequential indexes to a TCI codepoint. The IDs of the configured joint DL and UL TCI states may be non-unique TCI state IDs. For example, the received MAC-CE may be associated with joint DL and UL TCI states, and not associated with DL TCI states or UL TCI states. For another example, the received MAC-CE may be associated with joint DL and UL TCI states, and at least one of DL TCI states or UL TCI states, and the MAC-CE may indicate which subsets of TCI states in the MAC-CE are joint DL and UL TCI states, DL TCI states, and UL TCI states. The IDs of the configured joint DL and UL TCI states may be unique TCI state IDs, and the received MAC-CE may be associated with joint DL and UL TCI states, and at least one of DL TCI states or UL TCI states. For example, at 506, the UE 502 may receive a MAC-CE from the base station 504, the MAC-CE activating a subset of configured joint DL and UL TCI states, each activated joint DL and UL TCI state indicating a common beam for communication in DL and UL. Furthermore, 602 may be performed by an activation component 1644.

At 604, UE may receive a configuration indicating applicable DL/UL types or resources for activated joint DL/UL TCI states from the base station. The applicable DL/UL types or resources may include one or more of the PDCCH, the PDSCH, the CSI-RS, or the PRS for the DL, and one or more of the PUCCH, the PUSCH, the SRS, or the PRACH for the UL. That is, the UE may receive, from the base station, a configuration indicating which of a PDCCH, a PDSCH, a CSI-RS, a PRS, or an SSB is applicable for each of the activated joint DL and UL TCI states, and indicating which of a PUCCH, a PUSCH, an SRS, or a PRACH is applicable for each of the activated joint DL and UL TCI states (e.g., as at 508). The configuration may be received through one or more of RRC signaling, a MAC-CE, and/or DCI. For example, at 508, the UE 502 may receive a configuration indicating applicable DL/UL types or resources for activated joint DL/UL TCI states from the base station 504. Furthermore, 604 may be performed by a configuration component 1640.

At 606, the UE may receive, from the base station, a DCI indicating an index of a TCI codepoint, the index corresponding to one of the activated joint DL and UL TCI states (e.g., as at 510). The received DCI may not schedule the communication through DL or UL. The received DCI may schedule the communication through DL or UL, and the communication through DL or UL scheduled through the DCI may be based on the one activated DL and UL TCI state corresponding to the index of the TCI codepoint that is indicated through the DCI. For example, at 510, the UE 502 may receive a DCI indicating an index of a TCI codepoint, the index corresponding to one of the activated joint DL and UL TCI states from the base station 504. Furthermore, 606 may be performed by the activation component 1644.

At 608, the UE may transmit an acknowledgment to the base station confirming reception of the DCI (e.g., as at 512). For example, at 5XX, the UE 502 may transmit an acknowledgment to the base station confirming reception of the DCI. Furthermore, 608 may be performed by an ACK/NACK component 1642.

At 610, The UE may receive an indication of the DL resources and the UL resources for the communication from the base station. That is, the UE may receive, from the base station, an indication of the DL resources and the UL resources for the communication, and the DL resources and the UL resources for the communication may be determined based on the received indication (e.g., as at 514). The indication may be received through one of the RRC signaling, the MAC-CE, or the DCI. For example, at 514, the UE 502 may receive an indication of the DL resources and the UL resources for the communication from the base station 504. Furthermore, 610 may be performed by the activation component 1644.

At 612, the UE may determine DL resources and UL resources for the communication to which the one activated joint DL and UL TCI state corresponding to the index of the TCI codepoint indicated through the DCI applies (e.g., as at 516). The DL resources and the UL resources for the communication may be determined based on a predefined rule. The DL resources and the UL resources for the communication may be determined based on the indication received at 610. For example, at 5XX, the UE 502 may determine DL resources and UL resources for the communication to which the one activated joint DL and UL TCI state corresponding to the index of the TCI codepoint indicated through the DCI applies. Furthermore, 612 may be performed by the application component 1646.

At 614, the UE may communicate through DL and UL with the base station based on the activated joint DL and UL TCI states (e.g., as at 518). The communicating through the DL and the UL with the base station may be through at least one of a serving cell at the base station associated with the serving cell ID or a BWP associated with the BWP ID. When a received DCI schedules the communication through DL or UL, the communication through DL or UL scheduled through the DCI may be based on the one activated DL and UL TCI state corresponding to the index of the TCI codepoint that is indicated through the DCI. For example, at 518, the UE 502 and the base station 504 may communicate with each other through DL and UL based on the activated joint DL and UL TCI states. Furthermore, 614 may be performed by the application component 1646.

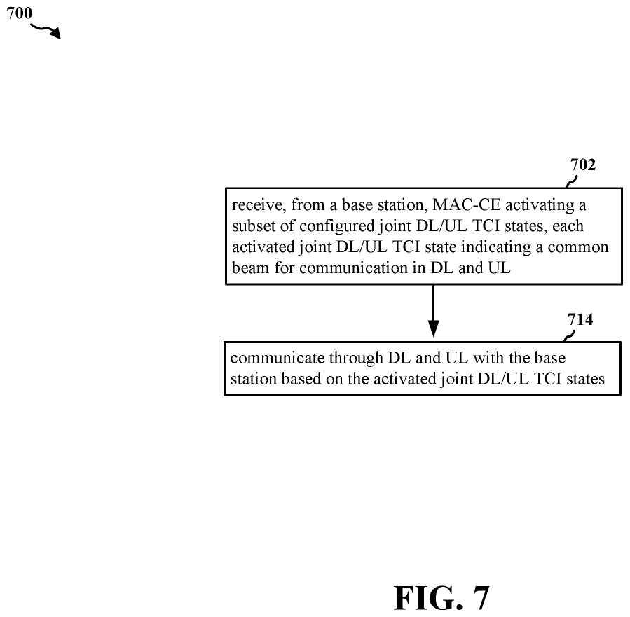

FIG. 7 is a flowchart 700 of a method of wireless communication. The method may be performed by a UE (e.g., the UE 104/502; the apparatus 1602). The UE may receive, from a base station, a configuration of the common beam indication via the joint DL/UL TCI state and the activation of the joint DL/UL TCI state via the MAC-CE.

At 702, the UE may receive, from a base station, a MAC-CE activating a subset of configured joint DL and UL TCI states, each activated joint DL and UL TCI state indicating a common beam for communication in DL and UL (e.g., as at 506). The MAC-CE may include a bitmap indicating which configured joint DL and UL TCI states are activated, and at least one of a serving cell ID associated with the base station or a BWP ID for which the activation applies. Each activated joint DL and UL TCI state may be associated with at least one of a PDCCH, a PDSCH, CSI-RS, PRS, or a SSB for DL, and at least one of a PUCCH, a PUSCH, SRS, or a PRACH for UL. The joint DL and UL TCI states activated in the MAC-CE may be mapped with sequential indexes to a TCI codepoint. The IDs of the configured joint DL and UL TCI states may be non-unique TCI state IDs. For example, the received MAC-CE may be associated with joint DL and UL TCI states, and not associated with DL TCI states or UL TCI states. For another example, the received MAC-CE may be associated with joint DL and UL TCI states, and at least one of DL TCI states or UL TCI states, and the MAC-CE may indicate which subsets of TCI states in the MAC-CE are joint DL and UL TCI states, DL TCI states, and UL TCI states. The IDs of the configured joint DL and UL TCI states may be unique TCI state IDs, and the received MAC-CE may be associated with joint DL and UL TCI states, and at least one of DL TCI states or UL TCI states. For example, at 506, the UE 502 may receive a MAC-CE from the base station 504, the MAC-CE activating a subset of configured joint DL and UL TCI states, each activated joint DL and UL TCI state indicating a common beam for communication in DL and UL. Furthermore, 702 may be performed by an activation component 1644.

At 714, the UE may communicate through DL and UL with the base station based on the activated joint DL and UL TCI states (e.g., as at 518). The communicating through the DL and the UL with the base station may be through at least one of a serving cell at the base station associated with the serving cell ID or a BWP associated with the BWP ID. When a received DCI schedules the communication through DL or UL, the communication through DL or UL scheduled through the DCI may be based on the one activated DL and UL TCI state corresponding to the index of the TCI codepoint that is indicated through the DCI. For example, at 518, the UE 502 and the base station 504 may communicate with each other through DL and UL based on the activated joint DL and UL TCI states. Furthermore, 714 may be performed by the application component 1646.

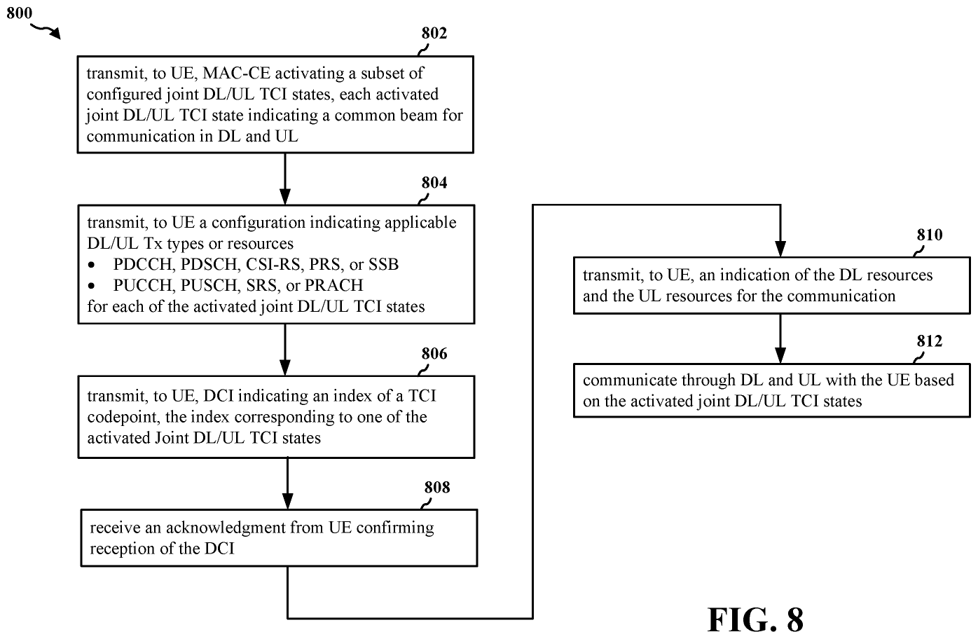

FIG. 8 is a flowchart 800 of a method of wireless communication. The method may be performed by a base station (e.g., the base station 102/180/504; the apparatus 1702). The base station may signal a common beam indication to a UE via a joint DL/UL TCI state, and activate the joint DL/UL TCI state using a MAC-CE.

At 802, the base station may transmit, to a UE, a MAC-CE activating a subset of configured joint DL and UL TCI states, each activated joint DL and UL TCI state indicating a common beam for communication in DL and UL (e.g., as at 506). The MAC-CE may include a bitmap indicating which configured joint DL and UL TCI states are activated, and at least one of a serving cell ID associated with the base station or a BWP ID for which the activation applies. Each activated joint DL and UL TCI state may be associated with at least one of a PDCCH, a PDSCH, CSI-RS, PRS, or a SSB for DL, and at least one of a PUCCH, a PUSCH, SRS, or a PRACH for UL. The joint DL and UL TCI states activated in the MAC-CE may be mapped with sequential indexes to a TCI codepoint. The IDs of the configured joint DL and UL TCI states may be non-unique TCI state IDs. For example, the received MAC-CE may be associated with joint DL and UL TCI states, and not associated with DL TCI states or UL TCI states. In another example, the received MAC-CE may be associated with joint DL and UL TCI states, and at least one of DL TCI states or UL TCI states, and the MAC-CE may indicate which subsets of TCI states in the MAC-CE are joint DL and UL TCI states, DL TCI states, and UL TCI states. The IDs of the configured joint DL and UL TCI states may be unique TCI state IDs, and the received MAC-CE may be associated with joint DL and UL TCI states, and at least one of DL TCI states or UL TCI states. For example, at 506, the base station 504 may transmit a MAC-CE to the UE 502, the MAC-CE activating a subset of configured joint DL and UL TCI states, each activated joint DL and UL TCI state indicating a common beam for communication in DL and UL. Furthermore, 802 may be performed by an activation component 1744.

At 804, the base station may transmit a configuration indicating applicable DL/UL types or resources for activated joint DL/UL TCI states to the UE. The applicable DL/UL types or resources may include one or more of the PDCCH, the PDSCH, the CSI-RS, or the PRS for the DL, and one or more of the PUCCH, the PUSCH, the SRS, or the PRACH for the UL. That is, the base station may transmit, to the UE, a configuration indicating which of a PDCCH, a PDSCH, a CSI-RS, a PRS, or an SSB is applicable for each of the activated joint DL and UL TCI states, and indicating which of a PUCCH, a PUSCH, an SRS, or a PRACH is applicable for each of the activated joint DL and UL TCI states (e.g., as at 508). The configuration may be received through at least one of RRC signaling, a MAC-CE, or DCI. For example, at 508, the base station 504 may transmit a configuration indicating applicable DL/UL types or resources for activated joint DL/UL TCI states to the UE 502. Furthermore, 804 may be performed by a configuration component 1740.

At 806, the base station may transmit, to the UE, a DCI indicating an index of a TCI codepoint, the index corresponding to one of the activated joint DL and UL TCI states (e.g., as at 510). The transmitted DCI may not schedule the communication through DL or UL. The received DCI may schedule the communication through DL or UL, and the communication through DL or UL scheduled through the DCI may be based on the one activated DL and UL TCI state corresponding to the index of the TCI codepoint that is indicated through the DCI. For example, at 510, the base station 504 may transmit a DCI indicating an index of a TCI codepoint, the index corresponding to one of the activated joint DL and UL TCI states to the UE 502. Furthermore, 806 may be performed by the configuration component 1740.

At 808, the base station may receive an acknowledgment from the UE confirming reception of the DCI (e.g., as at 512). For example, at 512, the base station 504 may receive, from the UE 502, the acknowledgement confirming the reception of the DCI. Furthermore, 808 may be performed by an ACK/NACK component 1742.

At 810, the base station may transmit, to the UE, an indication of the DL resources and the UL resources for the communication, where the DL resources and the UL resources for the communication are determined based on the received indication (e.g., as at 514). The indication may be transmitted through one of the RRC signaling, the MAC-CE, or the DCI. For example, at 514, the base station 504 may transmit an indication of the DL resources and the UL resources for the communication to the UE 502. Furthermore, 810 may be performed by the configuration component 1740.

At 812, the base station may communicate through DL and UL with the UE based on the activated joint DL and UL TCI states (e.g., as at 518). The communicating through the DL and the UL with the base station may be through at least one of a serving cell at the base station associated with the serving cell ID or a BWP associated with the BWP ID. When a received DCI schedules the communication through DL or UL, the communication through DL or UL scheduled through the DCI may be based on the one activated DL and UL TCI state corresponding to the index of the TCI codepoint that is indicated through the DCI. For example, at 518, the base station 504 and the UE 502 may communicate with each other through DL and UL based on the activated joint DL and UL TCI states. Furthermore, 812 may be performed by the application component 1746.

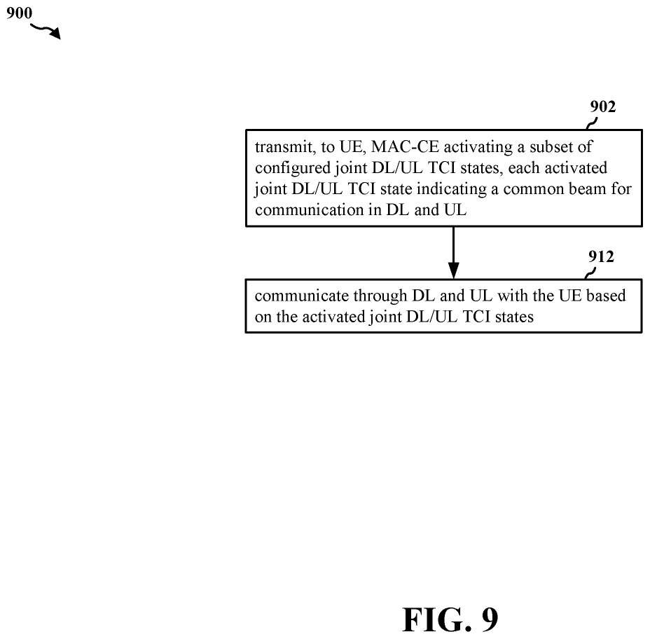

FIG. 9 is a flowchart 900 of a method of wireless communication. The method may be performed by a base station (e.g., the base station 102/180/504; the apparatus 1702). The base station may signal a common beam indication to a UE via a joint DL/UL TCI state, and activate the joint DL/UL TCI state using a MAC-CE.

At 902, the base station may transmit, to a UE, a MAC-CE activating a subset of configured joint DL and UL TCI states, each activated joint DL and UL TCI state indicating a common beam for communication in DL and UL (e.g., as at 506). The MAC-CE may include a bitmap indicating which configured joint DL and UL TCI states are activated, and at least one of a serving cell ID associated with the base station or a BWP ID for which the activation applies. Each activated joint DL and UL TCI state may be associated with at least one of a PDCCH, a PDSCH, CSI-RS, PRS, or a SSB for DL, and at least one of a PUCCH, a PUSCH, SRS, or a PRACH for UL. The joint DL and UL TCI states activated in the MAC-CE may be mapped with sequential indexes to a TCI codepoint. The IDs of the configured joint DL and UL TCI states may be non-unique TCI state IDs. For example, the received MAC-CE may be associated with joint DL and UL TCI states, and not associated with DL TCI states or UL TCI states. In another example, the received MAC-CE may be associated with joint DL and UL TCI states, and at least one of DL TCI states or UL TCI states, and the MAC-CE may indicate which subsets of TCI states in the MAC-CE are joint DL and UL TCI states, DL TCI states, and UL TCI states. The IDs of the configured joint DL and UL TCI states may be unique TCI state IDs, and the received MAC-CE may be associated with joint DL and UL TCI states, and at least one of DL TCI states or UL TCI states. For example, at 506, the base station 504 may transmit a MAC-CE to the UE 502, the MAC-CE activating a subset of configured joint DL and UL TCI states, each activated joint DL and UL TCI state indicating a common beam for communication in DL and UL. Furthermore, 902 may be performed by an activation component 1744.

At 912, the base station may communicate through DL and UL with the UE based on the activated joint DL and UL TCI states (e.g., as at 518). The communicating through the DL and the UL with the base station may be through at least one of a serving cell at the base station associated with the serving cell ID or a BWP associated with the BWP ID. When a received DCI schedules the communication through DL or UL, the communication through DL or UL scheduled through the DCI may be based on the one activated DL and UL TCI state corresponding to the index of the TCI codepoint that is indicated through the DCI. For example, at 518, the base station 504 and the UE 502 may communicate with each other through DL and UL based on the activated joint DL and UL TCI states. Furthermore, 912 may be performed by an application component 1746.

In wireless communications, signaling a common beam for multiple DL and UL resources may be utilized to save both beam indication overhead and latency. The common beam indication may be signaled via a joint DL/UL TCI state. Cross-CC activation of joint DL/UL TCI states may be similar to cross-CC activation of DL TCI states.

Aspects presented herein provide an enhancement on multi-beam operation, such as but not limited to, targeting frequency range 2 (FR2) while also being applicable to frequency range 1 (FR1). Aspects presented herein may facilitate more efficient, e.g., lower latency and overhead, DL/UL beam management to support higher intra and Layer-1/Layer-2 centric inter-cell mobility and/or a larger number of configured TCI states. For example, aspects may enable the configuration and/or activation of a common beam for data and control transmission/reception for DL and UL, especially for intra-band carrier aggregation (CA), a unified TCI framework for DL and UL beam indication, or enhancement on signaling mechanisms to improve latency and efficiency with more usage of dynamic control signaling, e.g., as compared to RRC signaling. Aspects may further facilitate UL beam selection for UEs equipped with multiple panels, considering UL coverage loss mitigation due to maximum permissible exposure (MPE), based on UL beam indication with the unified TCI framework for UL fast panel selection.

Aspects presented herein provide a configuration to allow a UE to activate a same joint TCI state ID or the ID of individual component in the joint TCI state ID across multiple CCs if a joint DL/UL TCI state is activated for a CC. The joint DL/UL TCI state may be activated for a CC in a MAC-CE and/or in a DCI.

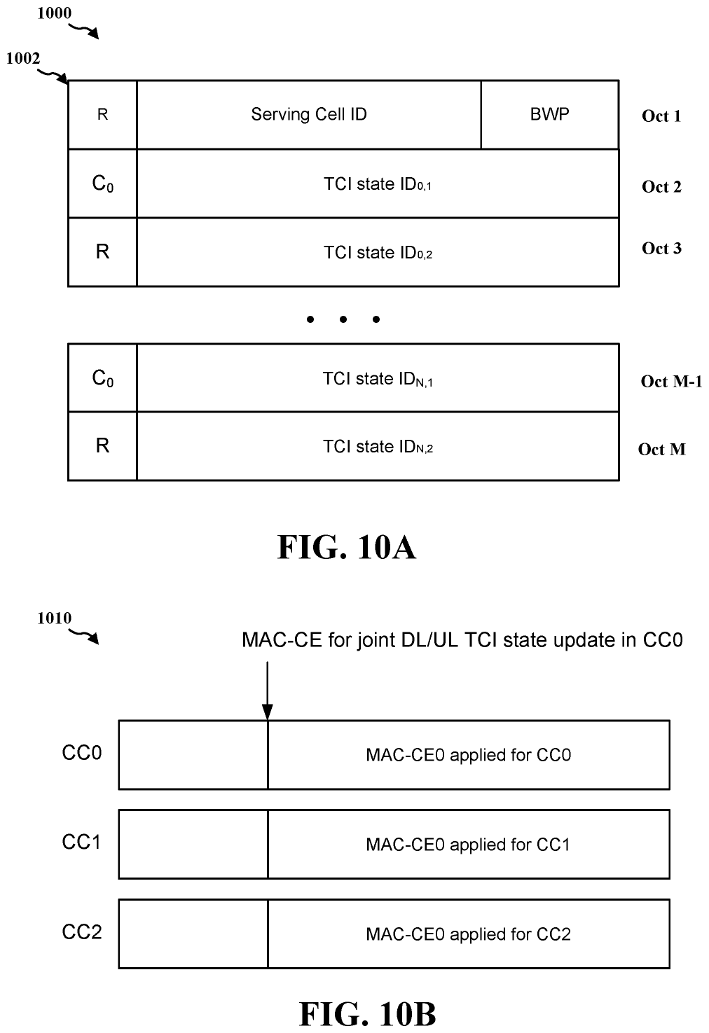

FIG. 10A is an example 1000 illustrating an example MAC-CE 1002 that may be used to activate joint DL/UL TCI states and DL/UL communication. The example in FIG. 10A is merely one example of a MAC-CE that may be used to activate a joint DL/UL TCI state. A MAC-CE including different content may also be used to activate the joint DL/UL TCI state, or a different message, such as DCI may be used to activate the joint DL/UL TCI state in other examples. For example, the activation may include the activation MAC-CE 400 of FIG. 4, which includes the bitmap indicating which configured joint DL/UL TCI states are activated, and the serving cell ID and/or the BWP ID for which the activation MAC-CE applies. The bitmap of the joint DL/UL TCI states may include each bit corresponding to each joint DL/UL TCI state. If a bit is set to 1, then the corresponding joint DL/UL TCI state may be activated. For example, the base station may configure up to 128 joint DL/UL TCI states, and the bitmap may have a bit length of 128 bits. The MAC-CE may select up to 8 bits, and therefore, the bitmap may have up to 8 bits set to 1 to activate the corresponding joint DL/UL TCI state. The UE may also receive, from the base station, DCI indicating an index of a TCI codepoint, the index corresponding to one of the activated joint DL and UL TCI states.

The MAC-CE 1002 may be a UE-specific MAC-CE for TCI state activation/deactivation, which is transmitted on PDSCH from a base station to a UE. The TCI state activation/deactivation for UE-specific MAC-CE is identified by a MAC PDU subheader. The MAC-CE 1002 may have a variable size bitmap including a serving cell ID field, a BWP ID field, a Cᵢ field, TCI state IDᵢⱼ field, and a reserved (R) field. The serving cell ID may indicate the identity of the serving cell for which the MAC-CE 1002 applies in the case of carrier aggregation (CA). The MAC-CE 1002 may activate the TCI states for any of data channel such as PDSCH, PUSCH, or control channel such as control resource set (CORESET), PUCCH, or RS signal such as CSI-RS and SRS for a UE. The length of the field may be 5 bits, for example. The BWP ID indicates a DL BWP for which the MAC-CE 1002 applies as the codepoint. The length of the BWP ID field may be 2 bits, for example. The Cᵢ field indicates whether the octet containing TCI state ID_{i,2} is present for the ith TCI codepoint (i=0, . . . N). If this field is set to “1”, the octet containing TCI state ID_{i,2} is present. If this field is set to “0”, the octet containing TCI state ID_{i,2} is not present. The TCI state IDᵢⱼ field indicates the TCI state, where i is the index of the codepoint and TCI state IDᵢⱼ denotes the j^{th} TCI state indicated for the i^{th} codepoint. The TCI codepoint to which the TCI states are mapped is determined by its ordinal position among all the TCI codepoints with sets of TCI state IDᵢⱼ fields, i.e., the first TCI codepoint with TCI state ID_{0,1} and TCI state ID_{0,2} is mapped to the codepoint value 0, the second TCI codepoint with TCI state ID_{1,1} and TCI state ID_{i,2} is mapped to the codepoint value 1, and so on. The TCI state ID_{i,2} may be optional based on the indication of the Cᵢ field. The maximum number of activated TCI codepoints may be 8 (accordingly, N<7) and the maximum number of TCI states mapped to a TCI codepoint may be 2. In one configuration, the maximum number of TCI states mapped to a TCI codepoint may greater than 2. When the number of TCI states mapped to a TCI codepoint is M>2 (TCI state ID_{i,m}, m=1, M), there may be a number of M-1 Cᵢ field for a TCI codepoint, respectively indicating that whether each of the TCI state ID_{i,m} is present or not, where m=2, . . . , M. The R field is a reserved bit that may be set to “0”.

In case of single-DCI based multi-TRP, one TRP can schedule DL receptions or UL transmissions simultaneously with each of multiple TRPs by sending a single scheduling DCI. In this case, the corresponding activation MAC-CE may activate at least one set of at least one joint DL/UL TCI state. At least in case of a single activated set, each of the multiple activated joint DL/UL TCI states may be sequentially applied to DL receptions or UL transmissions associated with each of the multiple scheduled TRPs. For example, if a MAC-CE activates the 0th set with two joint DL/UL TCI states, the two joint TCI states are 1-to-1 mapped to two TRPs scheduled by all scheduling DCIs, where the channel types or resources of DL receptions or UL transmissions per scheduled TRP is dynamically indicated in each scheduling DCI. The channel types or resources for DL receptions associated with a TRP can be such as PDSCH, PDCCH or COREST, CSI-RS, and the channel types or resources for UL transmission associated with a TRP can be such as PUSCH, PUCCH, SRS, or PRACH. Therefore, each scheduling DCI may not have a field of TCI codepoint and may not need to specify the used joint TCI state for channel types or resources of DL receptions or UL transmissions per scheduled TRP. Resources for DL receptions or UL transmissions with multiple scheduled TRPs may be frequency division multiplexed (FDMed), time division multiplexed (TDMed), or spatially division multiplexed (SDMed), which may be dynamically indicated in each scheduling DCI. For example, a 1^{st} scheduling DCI schedules two FDMed PDSCHs with two TDMed PUCCHs associated with two TRPs, and a 2^{nd} scheduling DCI schedules two TDMed PUSCHs associated with two TRPs. For both scheduling DCIs, the two joint TCI states in the 0^{th} set activated by the MAC-CE may be applied to resources allocated for DL receptions or UL transmissions associated with the two TRPs, respectively. For example, 1^{st} joint TCI states may be applied to 1^{st} PDSCH in two FDMed PDSCHs, 1^{st} PUCCH in two TDMed PUCCHs, and 1^{st} PUSCH in two TDMed PUSCHs, and similarly, 2^{nd} joint TCI states may be applied to 2^{nd} PDSCH in two FDMed PDSCHs, 2^{nd} PUCCH in two TDMed PUCCHs, and 2^{nd} PUSCH in two TDMed PUSCHs. The mapping between joint TCI state and resources of DL receptions or UL transmissions associated with each TRP may be determined in the specification (i.e., predetermined) or dynamically by the base station via RRC/MAC-CE/DCI.

If multiple sets of joint TCI state(s) are activated by the MAC-CE, e.g., N+1 sets and N>0, a DCI may further indicate a TCI codepoint which is mapped to one of the multiple sets of TCI state(s). In a first configuration, the indicated TCI codepoint may be used for resources of DL receptions or UL transmissions scheduled by the same DCI indicating the TCI codepoint. For example, 1^{st}/2^{nd} joint TCI states may be applied to 1^{st}/2^{nd} PDSCH and 1^{st}/2^{nd} PUCCH scheduled by this DCI, respectively. In a second configuration, the indicated TCI codepoint may be used for DL receptions or UL transmissions scheduled by all the following scheduling DCIs. For example, a first DCI may indicate one TCI codepoint which is mapped to a set of 1^{st} and 2^{nd} joint TCI states, and 1^{st}/2^{nd} joint TCI states may be applied to resources of DL receptions or UL transmissions for 1^{st}/2^{nd} TRPs scheduled by all the scheduling DCIs following the first DCI. Within the multiple TCI codepoints corresponding to multiple activated sets of joint DL/UL TCI states, one TCI codepoint may be defined to indicate a set of default common beams, e.g., the TCI codepoint with lowest/highest codepoint ID, at least when no TCI codepoint is indicated by any DCI.

If a joint DL/UL TCI state is activated for a component carrier (CC), the same joint TCI state ID or the ID of individual components in the joint TCI state ID may be activated across multiple CCs. Thus, a base station may activate a joint DL/UL TCI state across multiple CCs by transmitting an indication to the UE to activate the joint DL/UL TCI state for one CC. The UE receiving the indication to activate the joint DL/UL TCI state for the single CC may apply the activation of the joint DL/UL TCI state to multiple CCs, e.g., the multiple CCs having an association with the single CC. The joint DL/UL TCI state can be activated by an indication of MAC-CE or DCI, which also indicates the CC/BWP ID for the activated joint TCI state to be applied. If the applied CC ID belongs to a configured CC list, the activated joint TCI state ID or the ID of individual components in the MAC-CE or DCI may be applied to every CC in the CC list. As a first example, the same joint DL/UL TCI state ID(s) may be applied to all BWPs of every CC in the CC list. As another example, the same joint DL/UL TCI state ID(s) may be applied to the active DL/UL BWP of every CC in the CC list. There can be at least one CC list configured by RRC for cross-CC activation of DL/UL TCI state. In a first example, the CC lists can be dedicated for the joint DL/UL TCI state. In a second example, the base station and UE may reuse CC lists for cross-CC activation of a DL TCI state or cross-CC activation of an UL TCI state. Besides the joint TCI state ID, the MAC-CE or DCI activating the joint DL/UL TCI state may include an ID of individual components for cross-CC activation. For example, the MAC-CE or DCI may indicate an ID of a source reference signal providing various DL quasi-co-location (QCL) assumptions and/or UL spatial relation information. A QCL assumption may include, for example, a Doppler shift, a Doppler spread, an average delay, a delay spread, a spatial receive or a spatial transmit parameters. The MAC-CE or DCI may indicate UL power control parameters, including one or more of a pathloss reference signal (such as a CSI-RS or other reference signal), a nominal power parameter (such a PO or other nominal power), a pathloss scaling factor (such as a or other scaling factor), a close-loop index (such as i0 or i1), an identifier of a power control group (such as a PC group ID), or a combination thereof. The MAC-CE or DCI may indicate UL timing advance parameters, including one or more of a timing advance (TA) group ID and/or TA value. The MAC-CE or DCI may indicate a UE panel ID or similar ID, e.g., an antenna port group ID, a beam group ID, etc.

FIG. 10B is an example 1010 illustrating a configured CC list for cross-CC activation. The configured CC list may be configured via RRC signaling, which may include the serving cells (e.g., CC0, CC1, CC2). In some instances, the UE may receive a MAC-CEO for updating one or more joint DL/UL TCI states in CC0, by indicating one or more joint DL/UL TCI state IDs in the MAC-CEO. Moreover, the MAC-CEO may contain an index for the CC0 which may indicate the serving cell intended to receive the update. The UE may apply the MAC-CEO for CC0 by activating the indicated joint DL/UL TCI states in CC0, in response to the receipt of the MAC-CEO. The updated/activated joint DL/UL TCI states for CC0 are corresponding to the joint DL/UL TCI states configured for CC0 of the same joint DL/UL TCI state IDs as indicated by the MAC-CEO. In some instances, the UE may determine that the CC0 may belong to a CC list, such that the UE may apply the same MAC-CEO to the other CCs within the CC list. Since the MAC-CEO indicates one or more joint DL/UL TCI state IDs, such that the TCI states may be applied to every CC in the CC list. For each CC in the CC list, the joint DL/UL TCI states configured for that CC, which are of the TCI state IDs same as indicated by the MAC-CEO are activated/updated. In some aspects, the same joint DL/UL TCI state ID may be applied to all BWPs of every CC in the CC list. In some aspects, the same joint DL/UL TCI state ID may be applied to active DL/UL BWP of every CC in the CC list. There may be at least one CC list configured by RRC for cross-CC activation of joint DL/UL TCI state. In some aspects, the list may be dedicated to joint DL/UL TCI state. In some aspects, the list may be reused for other CC lists, such as, cross-CC activation of DL or UL TCI state.

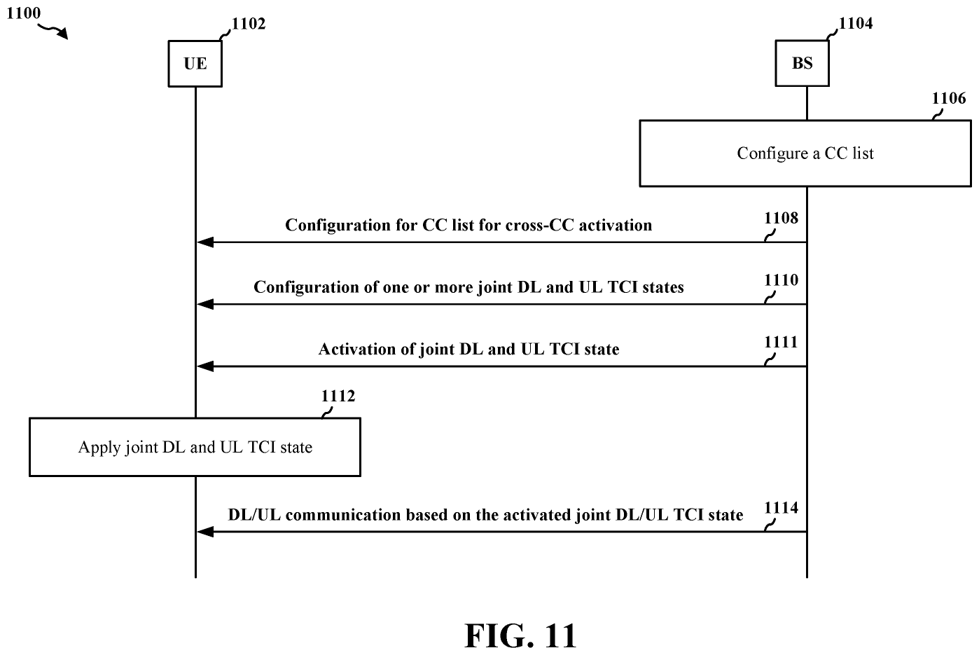

FIG. 11 is a call flow diagram 1100 of signaling between a UE 1102 and a base station 1104 including the activation of a joint DL and UL TCI state across multiple CCs. The base station 1104 may be configured to provide at least one cell. The base station may use a single transmission reception point (TRP) or multiple TRPs to communicate with the UE 1102. If the base station 404 uses multiple TRPs, the communication with the multiple TRPs may be based on a single DCI or may be based on multiple DCIs. For example, if multiple TRPs are used in the communication, the base station may use a single DCI to schedule the transmissions or receptions associated with different TRPs, or may use different DCIs to schedule the transmissions or receptions associated with different TRPs. The UE 1102 may be configured to communicate with the base station 1104. For example, in the context of FIG. 1, the base station 1104 may correspond to base station 102/180 and, accordingly, the cell may include a geographic coverage area 110 in which communication coverage is provided and/or small cell 102′ having a coverage area 110′. Further, a UE 1102 may correspond to at least UE 104. In another example, in the context of FIG. 3, the base station 1104 may correspond to base station 310 and the UE 1102 may correspond to UE 350.

As illustrated at 1106, the base station 1104 may configure a CC list comprising multiple CCs. In some aspects, the CC list may comprise a dedicated CC list for the cross-CC activation of the joint DL and UL TCI state. In some aspects, the CC list may be for the cross-CC activation of a DL TCI state or an UL TCI state. The base station may transmit the configuration of the CC list, at 1108, to the UE 1102. The base station may configure more than one CC list for the UE 1102 in some examples. The base station may configure the CC list(s) in RRC signaling to the UE 1102.

At 1110, the base station 1104 may configure one or more joint DL and UL TCI states for the UE 1102. The joint DL and UL TCI states may each indicate parameters, such as a beam, for downlink communication and uplink communication with the base station 1104. The joint DL and UL TCI state may indicate the parameters based on a source reference signal, for example. The base station may transmit the configuration of the joint DL and UL TCI states to the UE 1102 in RRC signaling, for example.

As illustrated at 1111, the base station 1104 may transmit an activation of at least one of the configured joint DL and UL TCI state for a CC comprised in the CC list to activate the joint DL and UL TCI state for each of the multiple CCs comprised in the list. Similarly, the base station 1104 may indicate a deactivation of the joint DL and UL TCI state. The base station may transmit the activation/deactivation of the joint DL and UL TCI state for a CC comprised in the CC list to a UE 1102, e.g., for a single CC. The UE 1102 may receive the activation of the joint DL and UL TCI state for the CC comprised in the CC list from the base station 1104. The joint DL and UL TCI state may indicate a common beam for communication in DL and UL. In some aspects, the activation of the joint DL and UL TCI state for the CC may be transmitted in one or more of a MAC-CE or DCI. For example, a set of joint DL and UL TCI states may be RRC configured and then a joint DL and UL TCI state from the configured set may be activated in more dynamic signaling (e.g., a MAC-CE or DCI). The MAC-CE or the DCI may indicate the CC or a BWP ID for which the joint DL and UL TCI state is activated. The UE may apply the activation of the joint DL and UL TCI state to each CC in a CC list configured at 1108 that includes the CC indicated in the MAC-CE/DCI activating the TCI state. Each CC may have multiple BWPs, e.g., up to 4 BWPs. In some aspects, the activation may activate the joint DL and UL TCI state for each BWP of each of the multiple CCs, e.g., each of the CCs in the CC list that includes the CC indicated in the MAC-CE/DCI. For example, the activation may include the activation MAC-CE 400 of FIG. 4, which includes the bitmap indicating which configured joint DL/UL TCI states are activated, and the serving cell ID and/or the BWP ID for which the activation MAC-CE applies. The bitmap of the joint DL/UL TCI states may include each bit corresponding to each joint DL/UL TCI state. If a bit is set to 1, then the corresponding joint DL/UL TCI state may be activated. For example, the base station may configure up to 128 joint DL/UL TCI states, and the bitmap may have a bit length of 128 bits. The MAC-CE may select up to 8 bits, and therefore, the bitmap may have up to 8 bits set to 1 to activate the corresponding joint DL/UL TCI state. The UE 1102 may also receive, from the base station 1104, DCI indicating an index of a TCI codepoint, the index corresponding to one of the activated joint DL and UL TCI states.

In some aspects, the activation 1111 may activate the joint DL and UL TCI state for an active BWP of each of the multiple CCs, e.g., rather than each BWP of each of the CCs. The active BWP may be a downlink BWP or an uplink BWP. The base station may transmit the activation 1111 of the joint DL and UL TCI state in a message that may indicate a joint TCI state ID and an ID of one or more component in the joint TCI state ID. In some aspects, the one or more component in the joint TCI state ID includes one or more of a reference signal ID, an uplink power control parameter, an uplink timing advance parameter, a UE panel ID, an antenna port ID, or a beam group ID.

In some aspects, for example as illustrated at 1108, the base station 1104 may transmit a configuration of a CC list for cross-CC activation of the joint DL and UL TCI state. The base station 1104 may transmit the configuration of the CC list for cross-CC activation of the joint DL and UL TCI state to the UE 1102. The UE 1102 may receive the configuration of the CC list for cross-CC activation of the joint DL and UL TCI state from the base station 1104. The UE 1102 may apply the joint DL and UL TCI state to each CC comprised in the CC list. The CC list may comprise a dedicated CC list for the cross-CC activation of the joint DL and UL TCI state. The CC list may be for the cross-CC activation of a DL TCI state or an UL TCI state.

As illustrated at 1112, the UE 1102 may apply the joint DL and UL TCI state to multiple CCs. The UE may apply the joint DL and UL TCI state to multiple CCs in response to receiving the activation of the joint DL and UL TCI state for the CC. The UE 1102 and the base station 1104 may exchange downlink and/or uplink communication 1114 based on the activation of the joint DL/UL TCI state. The downlink and/or uplink communication 1114 may be exchanged on multiple CCs based on the activated joint DL/UL TCI state.

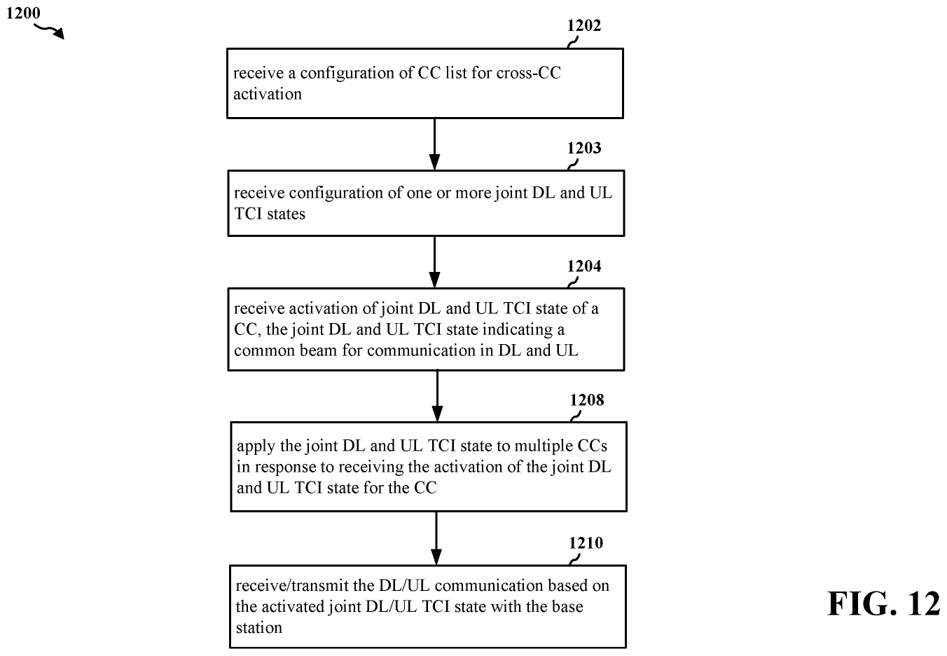

FIG. 12 is a flowchart 1200 of a method of wireless communication. The method may be performed by a UE or a component of a UE (e.g., the UE 104, 502; the apparatus 1602; the cellular baseband processor 1604, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. The method may allow a UE to activate a same joint TCI state ID or the ID of individual component in the joint TCI state ID across multiple CCs if a joint DL/UL TCI state is activated for a CC.

In some aspects, at 1202, the UE may receive a configuration of a CC list for cross-CC activation of the joint DL and UL TCI state. For example, at 1108, the UE 1102 may receive the configuration of the CC list from the base station 1104. Furthermore, 1202 may be performed by configuration component 1640 of apparatus 1602. The base station may configure more than one CC list for the UE in some examples, and the base station may configure the CC list(s) in RRC signaling to the UE. The UE may apply the joint DL and UL TCI state to each CC comprised in the CC list. The CC list may comprise a dedicated CC list for the cross-CC activation of the joint DL and UL TCI state. The CC list may be for the cross-CC activation of a DL TCI state or an UL TCI state.

At 1203, the UE may receive a configuration of one or more joint DL and UL TCI states for the base station. The joint DL and UL TCI states may each indicate parameters, such as a beam, for downlink communication and uplink communication with the base station. The joint DL and UL TCI state may indicate the parameters based on a source reference signal, for example. The base station may transmit the configuration of the joint DL and UL TCI states to the UE in RRC signaling. For example, at 1110, the UE 1102 may receive a configuration of one or more joint DL and UL TCI states from the base station 1104. Furthermore, 1203 may be performed by configuration component 1640 of apparatus 1602.

At 1204, the UE may receive an activation of a joint DL and UL TCI state for a CC. For example, at 1111, the UE 1102 may receive an activation of at least one of the configured joint DL and UL TCI state for a CC comprised in the CC list to activate the joint DL and UL TCI state for each of the multiple CCs comprised in the list. Furthermore, 1204 may be performed by activation component 1644 of apparatus 1602. The UE may receive the activation of the joint DL and UL TCI state for the CC from a base station. The joint DL and UL TCI state may indicate a common beam for communication in DL and UL. In some aspects, the activation of the joint DL and UL TCI state for the CC may be received in one or more of a MAC-CE or DCI. The MAC-CE or the DCI may indicate the CC or a BWP ID for which the joint DL and UL TCI state is activated. In some aspects, the CC may be associated with a list of the multiple CCs. The UE may apply the joint DL and UL TCI state to each CC in the list of the multiple CCs in response to receiving the activation of the joint DL and UL TCI state for the CC. In some aspects, the UE may apply the joint DL and UL TCI state to each BWP of each of the multiple CCs. In some aspects, the UE may apply the joint DL and UL TCI state to an active BWP of each of the multiple CCs. The active BWP may be a downlink BWP or an uplink BWP. In some aspects, the UE may receive the activation of the joint DL and UL TCI state in a message that indicates a joint TCI state ID and an ID of one or more component in the joint TCI state ID. The one or more component in the joint TCI state ID includes one or more of a reference signal ID, an uplink power control parameter, an uplink timing advance parameter, a UE panel ID, an antenna port ID, or a beam group ID. Similarly, the base station 1104 may indicate a deactivation of the joint DL and UL TCI state, and the base station may transmit the activation/deactivation of the joint DL and UL TCI state for a CC comprised in the CC list to a UE 1102, e.g., for a single CC.

At 1208, the UE may apply the joint DL and UL TCI state to multiple CCs. The UE may apply the joint DL and UL TCI state to multiple CCs in response to receiving the activation of the joint DL and UL TCI state for the CC. For example, at 1112, the UE 1102 may apply the joint DL and UL TCI state to multiple CCs. Furthermore, 1208 may be performed by application component 1646 of apparatus 1602. The UE may apply the joint DL and UL TCI state to multiple CCs in response to receiving the activation of the joint DL and UL TCI state for the CC.

At 1210, the UE may transmit/receive the downlink and/or uplink communication based on the activation of the joint DL/UL TCI state. The downlink and/or uplink communication may be exchanged on multiple CCs based on the activated joint DL/UL TCI state. For example, at 1114, the UE 1102 and the base station 1104 may exchange downlink and/or uplink communication based on the activation of the joint DL/UL TCI state. Furthermore, 1210 may be performed by application component 1646 of apparatus 1602.

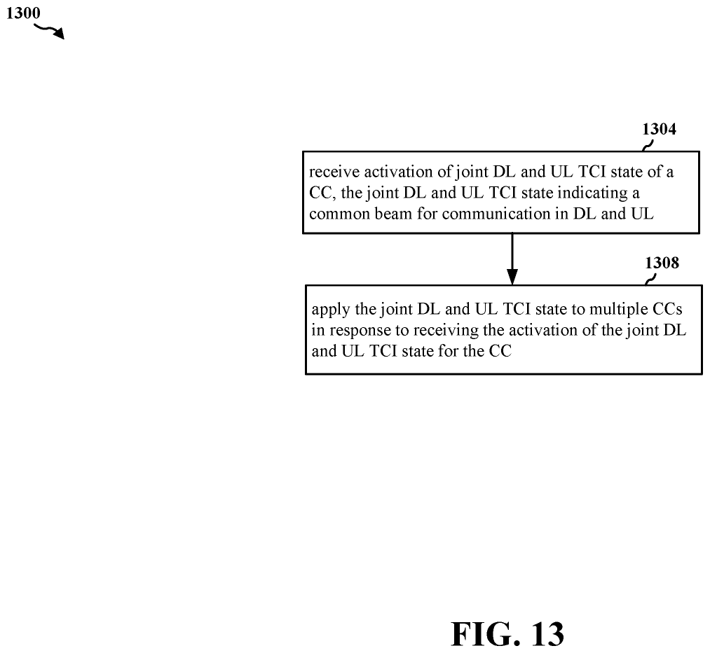

FIG. 13 is a flowchart 1300 of a method of wireless communication. The method may be performed by a UE or a component of a UE (e.g., the UE 104, 502; the apparatus 1602; the cellular baseband processor 1604, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. The method may allow a UE to activate a same joint TCI state ID or the ID of individual component in the joint TCI state ID across multiple CCs if a joint DL/UL TCI state is activated for a CC.

At 1304, the UE may receive an activation of a joint DL and UL TCI state for a CC. For example, at 1111, the UE 1102 may receive an activation of at least one of the configured joint DL and UL TCI state for a CC comprised in the CC list to activate the joint DL and UL TCI state for each of the multiple CCs comprised in the list. Furthermore, 1304 may be performed by activation component 1644 of apparatus 1602. The UE may receive the activation of the joint DL and UL TCI state for the CC from a base station. The joint DL and UL TCI state may indicate a common beam for communication in DL and UL. In some aspects, the activation of the joint DL and UL TCI state for the CC may be received in one or more of a MAC-CE or DCI. The MAC-CE or the DCI may indicate the CC or a BWP ID for which the joint DL and UL TCI state is activated. In some aspects, the CC may be associated with a list of the multiple CCs. The UE may apply the joint DL and UL TCI state to each CC in the list of the multiple CCs in response to receiving the activation of the joint DL and UL TCI state for the CC. In some aspects, the UE may apply the joint DL and UL TCI state to each BWP of each of the multiple CCs. In some aspects, the UE may apply the joint DL and UL TCI state to an active BWP of each of the multiple CCs. The active BWP may be a downlink BWP or an uplink BWP. In some aspects, the UE may receive the activation of the joint DL and UL TCI state in a message that indicates a joint TCI state ID and an ID of one or more component in the joint TCI state ID. The one or more component in the joint TCI state ID includes one or more of a reference signal ID, an uplink power control parameter, an uplink timing advance parameter, a UE panel ID, an antenna port ID, or a beam group ID. Similarly, the base station 1104 may indicate a deactivation of the joint DL and UL TCI state, and the base station may transmit the activation/deactivation of the joint DL and UL TCI state for a CC comprised in the CC list to a UE 1102, e.g., for a single CC.

At 1308, the UE may apply the joint DL and UL TCI state to multiple CCs. The UE may apply the joint DL and UL TCI state to multiple CCs in response to receiving the activation of the joint DL and UL TCI state for the CC. For example, at 1112, the UE 1102 may apply the joint DL and UL TCI state to multiple CCs. Furthermore, 1308 may be performed by application component 1646 of apparatus 1602. The UE may apply the joint DL and UL TCI state to multiple CCs in response to receiving the activation of the joint DL and UL TCI state for the CC.

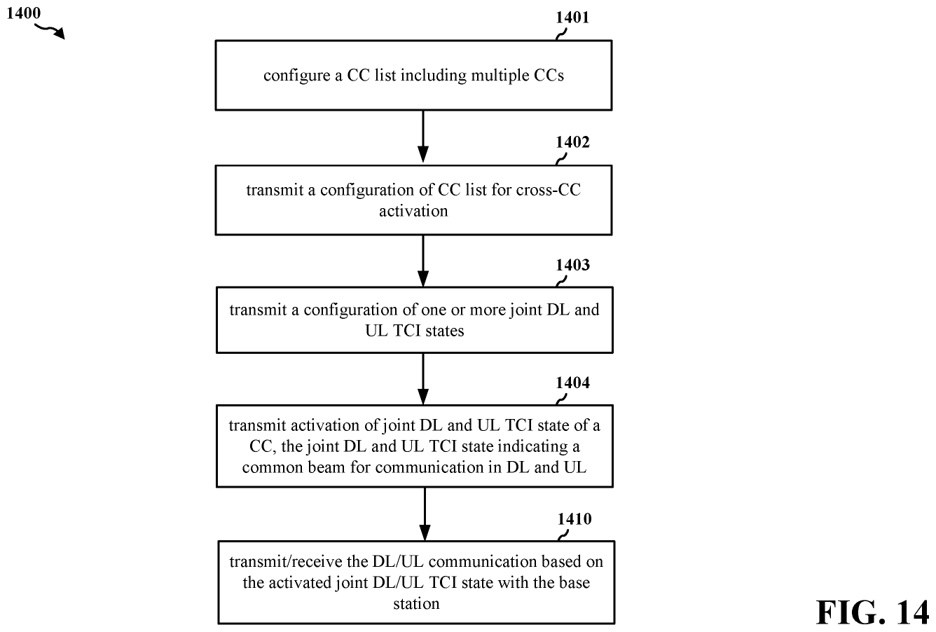

FIG. 14 is a flowchart 1400 of a method of wireless communication. The method may be performed by a base station or a component of a base station (e.g., the base station 102/180, 504; the apparatus 1702; the baseband unit 1704, which may include the memory 376 and which may be the entire base station 310 or a component of the base station 310, such as the TX processor 316, the RX processor 370, and/or the controller/processor 375). One or more of the illustrated operations may be omitted, transposed, or contemporaneous. The method may allow a base station to configure a UE to activate a same joint TCI state ID or the ID of individual component in the joint TCI state ID across multiple CCs if a joint DL/UL TCI state is activated for a CC.

At 1401, the base station may configure a CC list comprising multiple CCs. For example, at 1106, the base station 1104 may configure a CC list comprising multiple CCs. Furthermore, 1401 may be performed by configuration component 1740 of apparatus 1702. In some aspects, the CC list may comprise a dedicated CC list for the cross-CC activation of the joint DL and UL TCI state. In some aspects, the CC list may be for the cross-CC activation of a DL TCI state or an UL TCI state.

At 1402, the base station may transmit a configuration of CC list for cross-CC activation. For example, at 1108, the base station 1104 may transmit the configuration of the CC list to the UE 1102. Furthermore, 1402 may be performed by configuration component 1740 of apparatus 1702. The base station may transmit the configuration of the CC list to the UE, and the base station may configure more than one CC list for the UE 1102 in some examples. The base station may configure the CC list(s) in RRC signaling to the UE. In some aspects, the CC list may comprise a dedicated CC list for the cross-CC activation of the joint DL and UL TCI state. In some aspects, the CC list may be for the cross-CC activation of a DL TCI state or an UL TCI state.

At 1403, the base station may transmit a configuration of one or more joint DL and UL TCI states for the UE. For example, at 1110, the base station 1104 may configure one or more joint DL and UL TCI states for the UE 1102. Furthermore, 1402 may be performed by configuration component 1740 of apparatus 1702. The joint DL and UL TCI states may each indicate parameters, such as a beam, for downlink communication and uplink communication with the base station. The joint DL and UL TCI state may indicate the parameters based on a source reference signal, for example. The base station may transmit the configuration of the joint DL and UL TCI states to the UE in RRC signaling.

At 1404, the base station may transmit an activation of a joint DL and UL TCI state for a CC comprised in the CC list to activate the joint DL and UL TCI state for each of the multiple CCs comprised in the list. For example, at 1111, the base station 1104 may transmit an activation of at least one of the configured joint DL and UL TCI state for a CC comprised in the CC list to activate the joint DL and UL TCI state for each of the multiple CCs comprised in the list. Furthermore, 1404 may be performed by activation component 1744 of apparatus 1702. The base station may transmit the activation of the joint DL and UL TCI state for the CC comprised in the CC list to a UE. The joint DL and UL TCI state may indicate a common beam for communication in DL and UL. In some aspects, the activation of the joint DL and UL TCI state for the CC may be transmitted in one or more of a MAC-CE or DCI. The MAC-CE or the DCI may indicate the CC or a BWP ID for which the joint DL and UL TCI state is activated. In some aspects, the activation may activate the joint DL and UL TCI state for each BWP of each of the multiple CCs. In some aspects, the activation activates the joint DL and UL TCI state for an active BWP of each of the multiple CCs. The active BWP may be a downlink BWP or an uplink BWP. The base station may transmit the activation of the joint DL and UL TCI state in a message that may indicate a joint TCI state ID and an ID of one or more component in the joint TCI state ID. In some aspects, the one or more component in the joint TCI state ID includes one or more of a reference signal ID, an uplink power control parameter, an uplink timing advance parameter, a UE panel ID, an antenna port ID, or a beam group ID. Similarly, the base station 1104 may indicate a deactivation of the joint DL and UL TCI state, and the base station may transmit the activation/deactivation of the joint DL and UL TCI state for a CC comprised in the CC list to a UE 1102, e.g., for a single CC.

At 1410, the base station may transmit/receive the downlink and/or uplink communication based on the activation of the joint DL/UL TCI state. The downlink and/or uplink communication may be exchanged on multiple CCs based on the activated joint DL/UL TCI state. For example, at 1114, the base station 1104 and the UE 1102 may exchange downlink and/or uplink communication based on the activation of the joint DL/UL TCI state. Furthermore, 1410 may be performed by application component 1746 of apparatus 1702.

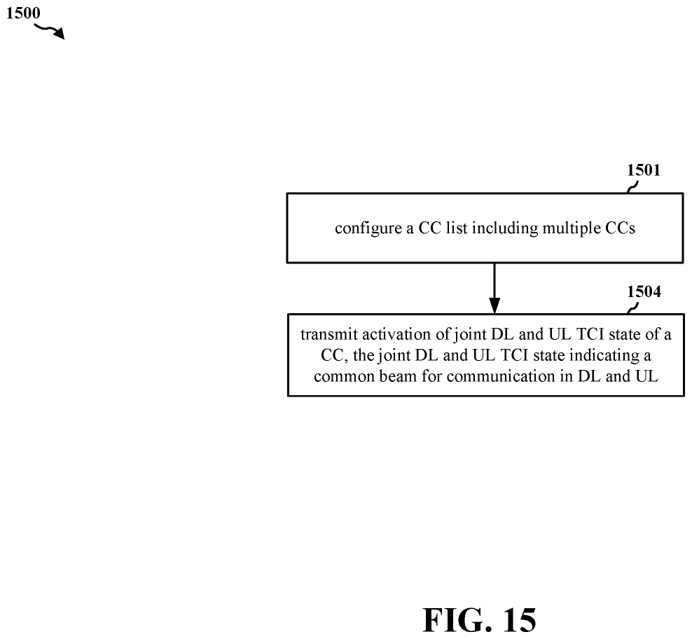

FIG. 15 is a flowchart 1500 of a method of wireless communication. The method may be performed by a base station or a component of a base station (e.g., the base station 102/180, 504; the apparatus 1702; the baseband unit 1704, which may include the memory 376 and which may be the entire base station 310 or a component of the base station 310, such as the TX processor 316, the RX processor 370, and/or the controller/processor 375). One or more of the illustrated operations may be omitted, transposed, or contemporaneous. The method may allow a base station to configure a UE to activate a same joint TCI state ID or the ID of individual component in the joint TCI state ID across multiple CCs if a joint DL/UL TCI state is activated for a CC.

At 1501, the base station may configure a CC list comprising multiple CCs. For example, at 1106, the base station 1104 may configure a CC list comprising multiple CCs. Furthermore, 1501 may be performed by configuration component 1740 of apparatus 1702. In some aspects, the CC list may comprise a dedicated CC list for the cross-CC activation of the joint DL and UL TCI state. In some aspects, the CC list may be for the cross-CC activation of a DL TCI state or an UL TCI state.

At 1504, the base station may transmit an activation of a joint DL and UL TCI state for a CC comprised in the CC list to activate the joint DL and UL TCI state for each of the multiple CCs comprised in the list. For example, at 1111, the base station 1104 may transmit an activation of at least one of the configured joint DL and UL TCI state for a CC comprised in the CC list to activate the joint DL and UL TCI state for each of the multiple CCs comprised in the list. Furthermore, 1504 may be performed by activation component 1744 of apparatus 1702. The base station may transmit the activation of the joint DL and UL TCI state for the CC comprised in the CC list to a UE. The joint DL and UL TCI state may indicate a common beam for communication in DL and UL. In some aspects, the activation of the joint DL and UL TCI state for the CC may be transmitted in one or more of a MAC-CE or DCI. The MAC-CE or the DCI may indicate the CC or a BWP ID for which the joint DL and UL TCI state is activated. In some aspects, the activation may activate the joint DL and UL TCI state for each BWP of each of the multiple CCs. In some aspects, the activation activates the joint DL and UL TCI state for an active BWP of each of the multiple CCs. The active BWP may be a downlink BWP or an uplink BWP. The base station may transmit the activation of the joint DL and UL TCI state in a message that may indicate a joint TCI state ID and an ID of one or more component in the joint TCI state ID. In some aspects, the one or more component in the joint TCI state ID includes one or more of a reference signal ID, an uplink power control parameter, an uplink timing advance parameter, a UE panel ID, an antenna port ID, or a beam group ID. Similarly, the base station 1104 may indicate a deactivation of the joint DL and UL TCI state, and the base station may transmit the activation/deactivation of the joint DL and UL TCI state for a CC comprised in the CC list to a UE 1102, e.g., for a single CC.

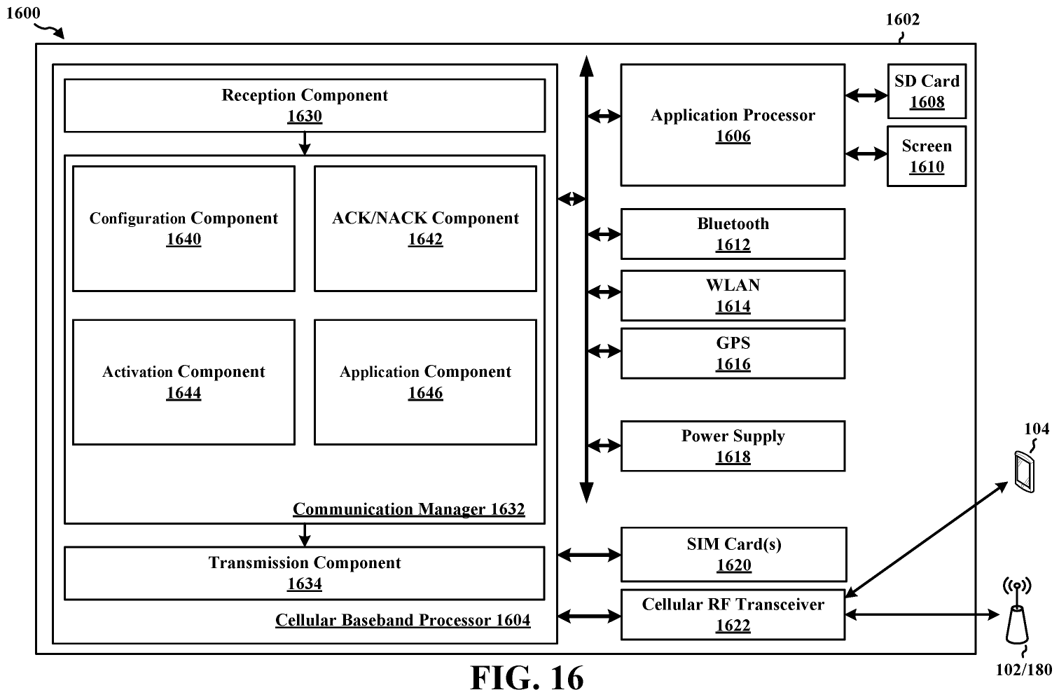

FIG. 16 is a diagram 1600 illustrating an example of a hardware implementation for an apparatus 1602. The apparatus 1602 may be a UE, a component of a UE, or may implement UE functionality. In some aspects, the apparatus 1602 may include a cellular baseband processor 1604 (also referred to as a modem) coupled to a cellular RF transceiver 1622. In some aspects, the apparatus 1602 may further include one or more subscriber identity modules (SIM) cards 1620, an application processor 1606 coupled to a secure digital (SD) card 1608 and a screen 1610, a Bluetooth module 1612, a wireless local area network (WLAN) module 1614, a Global Positioning System (GPS) module 1616, or a power supply 1618. The cellular baseband processor 1604 communicates through the cellular RF transceiver 1622 with the UE 104 and/or BS 102/180. The cellular baseband processor 1604 may include a computer-readable medium/memory. The computer-readable medium/memory may be non-transitory. The cellular baseband processor 1604 is responsible for general processing, including the execution of software stored on the computer-readable medium/memory. The software, when executed by the cellular baseband processor 1604, causes the cellular baseband processor 1604 to perform the various functions described supra. The computer-readable medium/memory may also be used for storing data that is manipulated by the cellular baseband processor 1604 when executing software. The cellular baseband processor 1604 further includes a reception component 1630, a communication manager 1632, and a transmission component 1634. The communication manager 1632 includes the one or more illustrated components. The components within the communication manager 1632 may be stored in the computer-readable medium/memory and/or configured as hardware within the cellular baseband processor 1604. The cellular baseband processor 1604 may be a component of the UE 350 and may include the memory 360 and/or at least one of the TX processor 368, the RX processor 356, and the controller/processor 359. In one configuration, the apparatus 1602 may be a modem chip and include just the baseband processor 1604, and in another configuration, the apparatus 1602 may be the entire UE (e.g., see 350 of FIG. 3) and include the additional modules of the apparatus 1602.

The communication manager 1632 includes a configuration component 1640 that is configured to receive a configuration indicating applicable DL/UL types or resources for activated joint DL/UL TCI states from the base station, receive a configuration of a CC list for cross-CC activation of the joint DL and UL TCI state, and receive a configuration of one or more joint DL and UL TCI states for the base station, e.g., as described in connection with 604, 1202, and 1203. The communication manager 1632 further includes an ACK/NACK component 1642 that is configured to transmit an acknowledgment to the base station confirming reception of the DCI, e.g., as described in connection with 608. The communication manager 1632 further includes an activation component 1644 that is configured to receive, from a base station, a MAC-CE activating a subset of configured joint DL and UL TCI states, receive, from the base station, a DCI indicating an index of a TCI codepoint, receive an indication of the DL resources and the UL resources for the communication from the base station, and receive an activation of a joint DL and UL TCI state for a CC, e.g., as described in connection with 602, 606, 610, 702, 1204, and 1304. The communication manager 1632 further includes an application component 1646 that is configured to determine DL resources and UL resources for the communication to which the one activated joint DL and UL TCI state corresponding to the index of the TCI codepoint indicated through the DCI applies, communicate through DL and UL with the base station based on the activated joint DL and UL TCI states, apply the joint DL and UL TCI state to multiple CCs, and transmit/receive the downlink and/or uplink communication based on the activation of the joint DL/UL TCI state, e.g., as described in connection with 612, 614, 714, 1208, 1210, and 1308.

The apparatus may include additional components that perform each of the blocks of the algorithm in the flowcharts of FIGS. 5, 6, 7, 11, 12, and 13. As such, each block in the flowcharts of FIGS. 5, 6, 7, 11, 12, and 13. may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1602 may include a variety of components configured for various functions. In one configuration, the apparatus 1602, and in particular the cellular baseband processor 1604, includes means for receiving, from a base station, a MAC-CE activating a subset of configured joint DL/UL TCI states, each activated joint DL and UL TCI state indicating a common beam for communication in DL and UL, and means for communicating through DL and UL with the base station based on the activated joint DL and UL TCI states. The apparatus 1602 also includes means for receiving, from the base station, a configuration indicating which of the PDCCH, the PDSCH, the CSI-RS, the PRS, or the SSB is applicable for each of the activated joint DL and UL TCI states, and indicating which of the PUCCH, the PUSCH, the SRS, or the PRACH is applicable for each of the activated joint DL and UL TCI states. The apparatus 1602 also includes means for receiving, from the base station, DCI indicating an index of a TCI codepoint, the index corresponding to one of the activated joint DL and UL TCI states, and means for transmitting an acknowledgment to the base station confirming reception of the DCI. The apparatus 1602 also includes means for determining DL resources and UL resources for the communication to which the one activated joint DL and UL TCI state corresponding to the index of the TCI codepoint indicated through the DCI applies. The apparatus 1602 also includes means for receiving, from the base station, an indication of the DL resources and the UL resources for the communication, where the DL resources and the UL resources for the communication are determined based on the received indication. The apparatus 1602 includes means for receiving, from a base station, an activation of a joint DL and UL TCI state for a CC. The joint DL and UL TCI state indicating a common beam for communication in DL and UL. The apparatus includes means for applying the joint DL and UL TCI state to multiple CCs in response to receiving the activation of the joint DL and UL TCI state for the CC. The apparatus further includes means for receiving a configuration of a CC list for cross-CC activation of the joint DL and UL TCI state. The UE applies the joint DL and UL TCI state to each CC comprised in the CC list. The means may be one or more of the components of the apparatus 1602 configured to perform the functions recited by the means. As described supra, the apparatus 1602 may include the TX Processor 368, the RX Processor 356, and the controller/processor 359. As such, in one configuration, the means may be the TX Processor 368, the RX Processor 356, and the controller/processor 359 configured to perform the functions recited by the means.

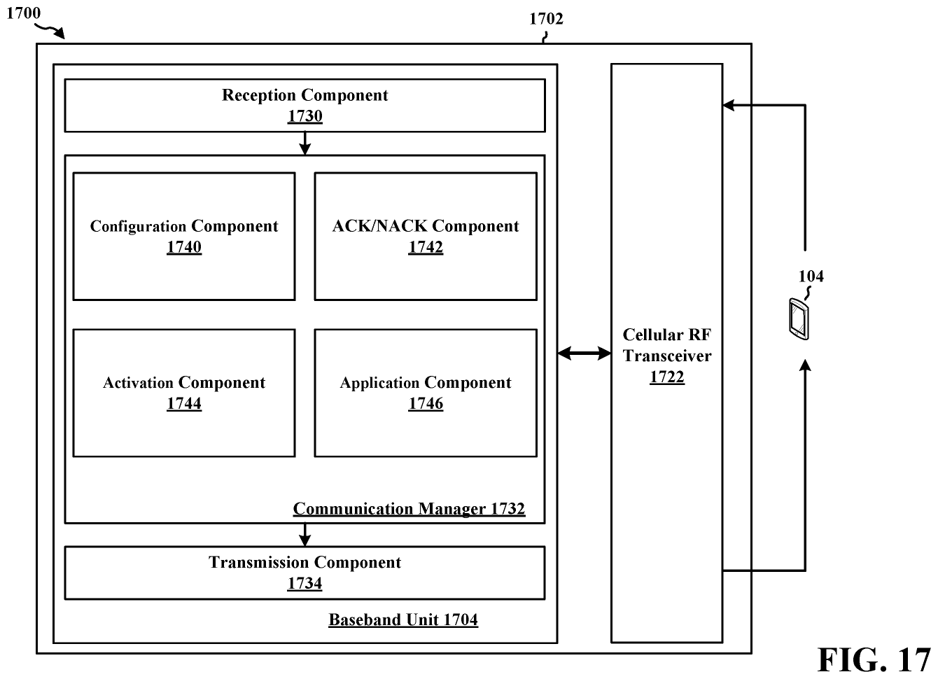

FIG. 17 is a diagram 1700 illustrating an example of a hardware implementation for an apparatus 1702. The apparatus 1702 may be a base station, a component of a base station, or may implement base station functionality. In some aspects, the apparatus 1602 may include a baseband unit 1704. The baseband unit 1704 may communicate through a cellular RF transceiver 1722 with the UE 104. The baseband unit 1704 may include a computer-readable medium/memory. The baseband unit 1704 is responsible for general processing, including the execution of software stored on the computer-readable medium/memory. The software, when executed by the baseband unit 1704, causes the baseband unit 1704 to perform the various functions described supra. The computer-readable medium/memory may also be used for storing data that is manipulated by the baseband unit 1704 when executing software. The baseband unit 1704 further includes a reception component 1730, a communication manager 1732, and a transmission component 1734. The communication manager 1732 includes the one or more illustrated components. The components within the communication manager 1732 may be stored in the computer-readable medium/memory and/or configured as hardware within the baseband unit 1704. The baseband unit 1704 may be a component of the base station 310 and may include the memory 376 and/or at least one of the TX processor 316, the RX processor 370, and the controller/processor 375.

The communication manager 1732 includes a configuration component 1740 that is configured to transmit a configuration indicating applicable DL/UL types or resources for activated joint DL/UL TCI states to the UE, transmit, to the UE, a DCI indicating an index of a TCI codepoint, transmit, to the UE, an indication of the DL resources and the UL resources for the communication, configure a CC list comprising multiple CCs, transmit a configuration of CC list for cross-CC activation, and transmit a configuration of one or more joint DL and UL TCI states for the UE, e.g., as described in connection with 804, 806, 810, 1401, 1402, 1403, and 1501. The communication manager 1732 further includes an ACK/NACK component 1742 that is configured to receive an acknowledgment from the UE confirming reception of the DCI, e.g., as described in connection with 808. The communication manager 1732 further includes an activation component 1744 that is configured to transmit, to a UE, a MAC-CE activating a subset of configured joint DL and UL TCI states, and transmit an activation of a joint DL and UL TCI state for a CC comprised in the CC list to activate the joint DL and UL TCI state for each of the multiple CCs comprised in the list, e.g., as described in connection with 802, 902, 1404, and 1504. The communication manager 1732 further includes an application component 1746 that is configured to communicate through DL and UL with the UE based on the activated joint DL and UL TCI states, and transmit/receive the downlink and/or uplink communication based on the activation of the joint DL/UL TCI state, e.g., as described in connection with 812, 912, and 1410.

The apparatus may include additional components that perform each of the blocks of the algorithm in the flowcharts of FIGS. 5, 8, 9, 11, 14, and 15. As such, each block in the flowcharts of FIGS. 5, 8, 9, 11, 14, and 15 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1702 may include a variety of components configured for various functions. In one configuration, the apparatus 1702, and in particular the baseband unit 1704, includes means for transmitting, to a UE, a MAC-CE activating a subset of configured joint DL/UL TCI states, each activated joint DL and UL TCI state indicating a common beam for communication in DL and UL, and means for communicating through DL and UL with the UE based on the activated joint DL and UL TCI states. The apparatus 1702 also includes means for transmitting, to the UE, a configuration indicating which of the PDCCH, the PDSCH, the CSI-RS, the PRS, or the SSB is applicable for each of the activated joint DL and UL TCI states, and indicating which of the PUCCH, the PUSCH, the SRS, or the PRACH is applicable for each of the activated joint DL and UL TCI states, and means for transmitting, to the UE, DCI indicating an index of a TCI codepoint, the index corresponding to one of the activated joint DL and UL TCI states. The apparatus 1702 also includes means for receiving an acknowledgment (ACK) from the UE confirming reception of the DCI, and means for transmitting, to the UE, an indication of DL resources and UL resources for the communication, where the DL resources and the UL resources for the communication to which the one activated joint DL and UL TCI state corresponding to the index of the TCI codepoint indicated through the DCI applies are determined based on the transmitted indication. The apparatus 1702 includes means for configuring a CC list comprising multiple CCs. The apparatus includes means for transmitting, to a user equipment, an activation of a joint DL and UL TCI state for a CC comprised in the CC list to activate the joint DL and UL TCI state for each of the multiple CCs comprised in the list. The joint DL and UL TCI state indicates a common beam for communication in DL and UL. The means may be one or more of the components of the apparatus 1702 configured to perform the functions recited by the means. As described supra, the apparatus 1702 may include the TX Processor 316, the RX Processor 370, and the controller/processor 375. As such, in one configuration, the means may be the TX Processor 316, the RX Processor 370, and the controller/processor 375 configured to perform the functions recited by the means.

The base station may transmit a MAC-CE to a UE, the MAC-CE activating a subset of configured joint DL and UL TCI states, each activated joint DL and UL TCI state indicating a common beam for communication in DL and UL. The base station may transmit a configuration indicating applicable DL/UL types or resources for activated joint DL/UL TCI states to the UE. The applicable DL/UL types or resources may include one or more of the PDCCH, the PDSCH, the CSI-RS, or the PRS for the DL, and one or more of the PUCCH, the PUSCH, the SRS, or the PRACH for the UL. The configuration may be received through at least one of the RRC signaling, the MAC-CE, and/or the DCI. The base station may transmit a DCI indicating an index of a TCI codepoint, the index corresponding to one of the activated joint DL and UL TCI states to the UE. The UE may transmit an acknowledgment to the base station confirming reception of the DCI. The base station may transmit an indication of the DL resources and the UL resources for the communication to the UE. The indication may be received through one of the RRC signaling, the MAC-CE, or the DCI. The UE may determine DL resources and UL resources for the communication to which the one activated joint DL and UL TCI state corresponding to the index of the TCI codepoint indicated through the DCI applies. The DL resources and the UL resources for the communication may be determined based on a predefined rule or the indication received. The UE and the base station may communicate with each other through DL and UL based on the activated joint DL and UL TCI states.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication including at least one processor coupled to a memory and configured to receive, from a base station, a MAC-CE activating a subset of configured joint DL and UL TCI states, each activated joint DL and UL TCI state indicating a common beam for communication in DL and UL, and communicate through DL and UL with the base station based on the activated joint DL and UL TCI states.

Aspect 2 is the apparatus of aspect 1, where the MAC-CE includes a bitmap indicating which configured joint DL and UL TCI states are activated, and at least one of a serving cell ID associated with the base station or a BWP ID for which the activation applies, the communicating through the DL and the UL with the base station being through at least one of a serving cell at the base station associated with the serving cell ID or a BWP associated with the BWP ID.

Aspect 3 is the apparatus of any of aspects 1 and 2, where each activated joint DL and UL TCI state is associated with at least one of a PDCCH, a PDSCH, CSI-RS, PRS, or a SSB for DL, and at least one of a PUCCH, a PUSCH, SRS, or a PRACH for UL.

Aspect 4 is the apparatus of aspects 3, where the at least one processor and the memory are further configured to receive, from the base station, a configuration indicating which of the PDCCH, the PDSCH, the CSI-RS, the PRS, or the SSB is applicable for each of the activated joint DL and UL TCI states, and indicating which of the PUCCH, the PUSCH, the SRS, or the PRACH is applicable for each of the activated joint DL and UL TCI states.

Aspect 5 is the apparatus of aspect 4, where the configuration is received through at least one of RRC signaling, a MAC-CE, or DCI.

Aspect 6 is the apparatus of any of aspects 1 to 5, where the at least one processor and the memory are further configured to receive, from the base station, downlink control information (DCI) indicating an index of a TCI codepoint, the index corresponding to one of the activated joint DL and UL TCI states.

Aspect 7 is the apparatus of aspect 6, where the received DCI does not schedule the communication through DL or UL.

Aspect 8 is the apparatus of aspect 7, where the at least one processor and the memory are further configured to transmit an acknowledgment to the base station confirming reception of the DCI.

Aspect 9 is the apparatus of any of aspects 6 to 8, where the received DCI schedules the communication through DL or UL, and the communication through DL or UL scheduled through the DCI is based on the one activated DL and UL TCI state corresponding to the index of the TCI codepoint that is indicated through the DCI.

Aspect 10 is the apparatus of any of aspects 6 to 9, where the at least one processor and the memory are further configured to determine DL resources and UL resources for the communication to which the one activated joint DL and UL TCI state corresponding to the index of the TCI codepoint indicated through the DCI applies.

Aspect 11 is the apparatus of aspect 10, where the DL resources and the UL resources for the communication are determined based on a predefined rule.

Aspect 12 is the apparatus of any of aspects 10 and 11, where the at least one processor and the memory are further configured to receive, from the base station, an indication of the DL resources and the UL resources for the communication, where the DL resources and the UL resources for the communication are determined based on the received indication.

Aspect 13 is the apparatus of aspect 12, where the indication is received through one of RRC signaling, a MAC-CE, or DCI.

Aspect 14 is the apparatus of any of aspects 1 to 13, where the joint DL and UL TCI states activated in the MAC-CE are mapped with sequential indexes to a TCI codepoint.

Aspect 15 is the apparatus of any of aspects 1 to 14, where identifiers (IDs) of the configured joint DL and UL TCI states are non-unique TCI state IDs.

Aspect 16 is the apparatus of aspect 15, where the received MAC-CE is associated with joint DL and UL TCI states, and is not associated with DL TCI states or UL TCI states.

Aspect 17 is the apparatus of any of aspects 15 to 16, where the received MAC-CE is associated with joint DL and UL TCI states, and at least one of DL TCI states or UL TCI states.

Aspect 18 is the apparatus of aspect 17, where the MAC-CE indicates which subsets of TCI states in the MAC-CE are joint DL and UL TCI states, DL TCI states, and UL TCI states.

Aspect 19 is the apparatus of aspect 18, where the received MAC-CE is associated with joint DL and UL TCI states, and at least one of DL TCI states or UL TCI states.

Aspect 20 is the apparatus of any of aspects 1 to 19, where IDs of the configured joint DL and UL TCI states are unique TCI state IDs.

Aspect 21 is a method of wireless communication for implementing any of aspects 1 to 20.

Aspect 22 is an apparatus for wireless communication including means for implementing any of aspects 1 to 20.

Aspect 23 is a computer-readable medium storing computer executable code, where the code when executed by a processor causes the processor to implement any of aspects 1 to 20.

Aspect 24 is an apparatus for wireless communication including at least one processor coupled to a memory and configured to transmit, to a UE, a MAC-CE activating a subset of configured joint DL and UL TCI states, each activated joint DL and UL TCI state indicating a common beam for communication in DL and UL, and communicate through DL and UL with the UE based on the activated joint DL and UL TCI states.

Aspect 25 is the apparatus of aspect 24, where the MAC-CE includes a bitmap indicating which configured joint DL and UL TCI states are activated, and at least one of a serving cell ID associated with the base station or a BWP ID for which the activation applies, the communicating through the DL and the UL with the UE being through at least one of a serving cell at the base station associated with the serving cell ID or a BWP associated with the BWP ID.

Aspect 26 is the apparatus of any of aspects 24 and 25, where each activated joint DL and UL TCI state is associated with at least one of a PDCCH, a PDSCH, CSI-RS, PRS, or a SSB for DL, and at least one of a PUCCH, a PUSCH, SRS, or a PRACH for UL.

Aspect 27 is the apparatus of aspect 26, where the at least one processor and the memory are further configured to transmit, to the UE, a configuration indicating which of the PDCCH, the PDSCH, the CSI-RS, the PRS, or the SSB is applicable for each of the activated joint DL and UL TCI states, and indicating which of the PUCCH, the PUSCH, the SRS, or the PRACH is applicable for each of the activated joint DL and UL TCI states.

Aspect 28 is the apparatus of aspect 27, where the configuration is transmitted through at least one of RRC signaling, a MAC-CE, or DCI.

Aspect 29 is the apparatus of any of aspects 24 to 28, where the at least one processor and the memory are further configured to transmit, to the UE, DCI indicating an index of a TCI codepoint, the index corresponding to one of the activated joint DL and UL TCI states.

Aspect 30 is the apparatus of aspect 29, where the transmitted DCI does not schedule the communication through DL or UL.

Aspect 31 is the apparatus of aspect 30, where the at least one processor and the memory are further configured to receive an ACK from the UE confirming reception of the DCI.

Aspect 32 is the apparatus of any of aspects 29 to 31, where the transmitted DCI schedules the communication through DL or UL, and the communication through DL or UL scheduled through the DCI is based on the one activated DL and UL TCI state corresponding to the index of the TCI codepoint that is indicated through the DCI.

Aspect 33 is the apparatus of any of aspects 29 to 32, where DL resources and UL resources for the communication to which the one activated joint DL and UL TCI state corresponding to the index of the TCI codepoint indicated through the DCI applies are determined based on a predefined rule.

Aspect 34 is the apparatus of any of aspects 29 to 33, where the at least one processor and the memory are further configured to transmit, to the UE, an indication of DL resources and UL resources for the communication, where the DL resources and the UL resources for the communication to which the one activated joint DL and UL TCI state corresponding to the index of the TCI codepoint indicated through the DCI applies are determined based on the transmitted indication.

Aspect 35 is the apparatus of aspect 34, where the indication is transmitted through one of RRC signaling, a MAC-CE, or DCI.

Aspect 36 is the apparatus of any of aspects 24 to 35, where the joint DL and UL TCI states activated in the MAC-CE are mapped with sequential indexes to a TCI codepoint.

Aspect 37 is the apparatus of any of aspects 24 to 36, where IDs of the configured joint DL and UL TCI states are non-unique TCI state IDs.

Aspect 38 is the apparatus of aspect 37, where the transmitted MAC-CE is associated with joint DL and UL TCI states, and is not associated with DL TCI states or UL TCI states.

Aspect 39 is the apparatus of any of aspects 37 and 38, where the transmitted MAC-CE is associated with joint DL and UL TCI states, and at least one of DL TCI states or UL TCI states.

Aspect 40 is the apparatus of aspect 39, where the MAC-CE indicates which subsets of TCI states in the MAC-CE are joint DL and UL TCI states, DL TCI states, and UL TCI states.

Aspect 41 is the apparatus of aspect 40, where the transmitted MAC-CE is associated with joint DL and UL TCI states, and at least one of DL TCI states or UL TCI states.

Aspect 42 is the apparatus of any of aspects 24 to 41, where IDs of the configured joint DL and UL TCI states are unique TCI state IDs.

Aspect 43 is a method of wireless communication for implementing any of aspects 24 to 43.

Aspect 44 is an apparatus for wireless communication including means for implementing any of aspects 24 to 43.

Aspect 45 is a computer-readable medium storing computer executable code, where the code when executed by a processor causes the processor to implement any of aspects 24 to 43.

Aspect 46 is an apparatus for wireless communication including at least one processor coupled to a memory and configured to receive, from a base station, an activation of a joint DL and UL TCI state for a CC, the joint DL and UL TCI state indicating a common beam for communication in DL and UL, and apply the joint DL and UL TCI state to multiple CCs in response to receiving the activation of the joint DL and UL TCI state for the CC.

Aspect 47 is the apparatus of aspect 46, where the activation of the joint DL and UL TCI state for the CC is received in one or more of a MAC-CE or DCI.

Aspect 48 is the apparatus of aspect 47, where the MAC-CE or the DCI indicates the CC or a BWP ID for which the joint DL and UL TCI state is activated.

Aspect 49 is the apparatus of any of aspects 46 to 48, where the CC is associated with a list of the multiple CCs, and where the at least one processor and the memory applies the joint DL and UL TCI state to each CC in the list of the multiple CCs in response to receiving the activation of the joint DL and UL TCI state for the CC.

Aspect 50 is the apparatus of aspect 49, where the at least one processor and the memory applies the joint DL and UL TCI state to each BWP of each of the multiple CCs.

Aspect 51 is the apparatus of any of aspects 46 to 50, where the at least one processor and the memory applies the joint DL and UL TCI state to an active BWP of each of the multiple CCs.

Aspect 52 is the apparatus of aspect 51, where the active BWP is a downlink BWP or an uplink BWP.

Aspect 53 is the apparatus of any of aspects 46 to 52, where the at least one processor and the memory are further configured to receive a configuration of a CC list for cross-CC activation of the joint DL and UL TCI state, where the at least one processor and the memory applies the joint DL and UL TCI state to each CC included in the CC list.

Aspect 54 is the apparatus of aspect 53, where the CC list includes a dedicated CC list for the cross-CC activation of the joint DL and UL TCI state.

Aspect 55 is the apparatus of any of aspects 46 to 54, where the CC list is for the cross-CC activation of a DL TCI state or an UL TCI state.

Aspect 56 is the apparatus of any of aspects 46 to 55, where the at least one processor and the memory receives the activation of the joint DL and UL TCI state in a message that indicates a joint TCI state ID and an ID of one or more component in the joint TCI state ID.

Aspect 57 is the apparatus of aspect 56, where the one or more component in the joint TCI state ID includes one or more of a reference signal ID, an uplink power control parameter, an uplink timing advance parameter, a UE panel ID, an antenna port ID, or a beam group ID.

Aspect 58 is the apparatus of any of aspects 46 to 57, where the activation is configured to activate a subset of configured joint DL and UL TCI states, each activated joint DL and UL TCI state indicating the common beam for communication in DL and UL.

Aspect 59 is the apparatus of any of aspects 46 to 58, where the at least one processor and the memory are further configured to receive, from the base station, DCI indicating an index of a TCI codepoint, the index corresponding to one of the activated joint DL and UL TCI states.

Aspect 60 is a method of wireless communication for implementing any of aspects 46 to 59.

Aspect 61 is an apparatus for wireless communication including means for implementing any of aspects 46 to 59.

Aspect 62 is a computer-readable medium storing computer executable code, where the code when executed by a processor causes the processor to implement any of aspects 46 to 59.

Aspect 63 is an apparatus for wireless communication including at least one processor coupled to a memory and configured to configure a CC list including multiple CCs, and transmit, to a user equipment (UE), an activation of a joint DL and UL TCI state for a CC included in the CC list to activate the joint DL and UL TCI state for each of the multiple CCs included in the list, where the joint DL and UL TCI state indicates a common beam for communication in DL and UL.

Aspect 46 is the apparatus of aspect 63, where the activation of the joint DL and UL TCI state for the CC is transmitted in one or more of a MAC-CE or DCI.

Aspect 65 is the apparatus of aspect 46, where the MAC-CE or the DCI indicates the CC or a BWP ID for which the joint DL and UL TCI state is activated.

Aspect 66 is the apparatus of any of aspects 63 to 65, where the activation activates the joint DL and UL TCI state for each BWP of each of the multiple CCs.

Aspect 67 is the apparatus of any of aspects 63 to 66, where the activation activates the joint DL and UL TCI state for an active BWP of each of the multiple CCs.

Aspect 68 is the apparatus of aspect 67, where the active BWP is a downlink BWP or an uplink BWP.

Aspect 69 is the apparatus of any of aspects 63 to 68, where the at least one processor and the memory are further configured to transmit a configuration of a CC list for cross-CC activation of the joint DL and UL TCI state.

Aspect 70 is the apparatus of any of aspects 63 to 69, where the CC list includes a dedicated CC list for the cross-CC activation of the joint DL and UL TCI state.

Aspect 71 is the apparatus of any of aspects 63 to 70, where the CC list is for the cross-CC activation of a DL TCI state or an UL TCI state.

Aspect 72 is the apparatus of any of aspects 63 to 71, where the at least one processor and the memory transmit the activation of the joint DL and UL TCI state in a message that indicates a joint TCI state ID and an ID of one or more component in the joint TCI state ID.

Aspect 73 is the apparatus of aspect 72, where the one or more component in the joint TCI state ID includes one or more of a reference signal ID, an uplink power control parameter, an uplink timing advance parameter, a UE panel ID, an antenna port ID, or a beam group ID.

Aspect 74 is the apparatus of any of aspects 63 to 73, where the activation is configured to activate a subset of configured joint DL and UL TCI states, each activated joint DL and UL TCI state indicating the common beam for communication in DL and UL.

Aspect 75 is the apparatus of any of aspects 63 to 74, where the at least one processor and the memory are further configured to transmit, to the UE, DCI indicating an index of a TCI codepoint, the index corresponding to one of the activated joint DL and UL TCI states.

Aspect 76 is a method of wireless communication for implementing any of aspects 63 to 75.

Aspect 77 is an apparatus for wireless communication including means for implementing any of aspects 63 to 75.

Aspect 78 is a computer-readable medium storing computer executable code, where the code when executed by a processor causes the processor to implement any of aspects 63 to 75.

What is claimed is:

1. An apparatus for wireless communication at a user equipment (UE), comprising:
a memory; and
at least one processor coupled to the memory, the at least one processor and the memory configured to:
receive, from a base station, an activation of a joint downlink (DL) and uplink (UL) transmission configuration indicator (TCI) state for a component carrier (CC), the joint DL and UL TCI state indicating a common beam for communication in DL and UL; and
apply the joint DL and UL TCI state to multiple CCs in response to receiving the activation of the joint DL and UL TCI state for the CC,
the activation being configured to activate a subset of configured joint DL and UL TCI states, each activated joint DL and UL TCI state indicating the common beam for communication in DL and UL.

2. The apparatus of claim 1, wherein the activation of the joint DL and UL TCI state for the CC is received in one or more of a medium access control (MAC) control element (CE) (MAC-CE) or downlink control information (DCI).

3. The apparatus of claim 2, wherein the MAC-CE or the DCI indicates the CC or a bandwidth part (BWP) identifier (ID) for which the joint DL and UL TCI state is activated.

4. The apparatus of claim 1, wherein the CC is associated with a list of the multiple CCs, and wherein the at least one processor and the memory apply the joint DL and UL TCI state to each CC in the list of the multiple CCs in response to receiving the activation of the joint DL and UL TCI state for the CC.

5. The apparatus of claim 4, wherein the at least one processor and the memory apply the joint DL and UL TCI state to each BWP of each of the multiple CCs.

6. The apparatus of claim 4, wherein the at least one processor and the memory apply the joint DL and UL TCI state to an active BWP of each of the multiple CCs.

7. The apparatus of claim 6, wherein the active BWP is a downlink BWP or an uplink BWP.

8. The apparatus of claim 1, wherein the at least one processor and the memory are further configured to:
receive a configuration of a CC list for cross-CC activation of the joint DL and UL TCI state,
wherein the at least one processor and the memory apply the joint DL and UL TCI state to each CC comprised in the CC list.

9. The apparatus of claim 8, wherein the CC list comprises a dedicated CC list for the cross-CC activation of the joint DL and UL TCI state.

10. The apparatus of claim 8, wherein the CC list is for the cross-CC activation of a DL TCI state or an UL TCI state.

11. The apparatus of claim 1, wherein the at least one processor and the memory receive the activation of the joint DL and UL TCI state in a message that indicates a joint TCI state identifier (ID) and an ID of one or more component in the joint TCI state ID.

12. The apparatus of claim 11, wherein the one or more component in the joint TCI state ID includes one or more of:
a reference signal ID,
an uplink power control parameter,
an uplink timing advance parameter,
a UE panel ID,
an antenna port ID, or
a beam group ID.

13. The apparatus of claim 1, wherein the at least one processor and the memory are further configured to receive, from the base station, downlink control information (DCI) indicating an index of a TCI codepoint, the index corresponding to one of the activated joint DL and UL TCI states.

14. An apparatus for wireless communication at a base station, comprising:
a memory; and
at least one processor coupled to the memory, the at least one processor and the memory configured to:
configure a component carrier (CC) list comprising multiple CCs; and
transmit, to a user equipment (UE), an activation of a joint downlink (DL) and uplink (UL) transmission configuration indicator (TCI) state for a CC comprised in the CC list to activate the joint DL and UL TCI state for each of the multiple CCs comprised in the list, wherein the joint DL and UL TCI state indicates a common beam for communication in DL and UL,
the activation being configured to activate a subset of configured joint DL and UL TCI states, each activated joint DL and UL TCI state indicating the common beam for communication in DL and UL.

15. The apparatus of claim 14, wherein the activation of the joint DL and UL TCI state for the CC is transmitted in one or more of a medium access control (MAC) control element (CE) (MAC-CE) or downlink control information (DCI).

16. The apparatus of claim 15, wherein the MAC-CE or the DCI indicates the CC or a bandwidth part (BWP) identifier (ID) for which the joint DL and UL TCI state is activated.

17. The apparatus of claim 14, wherein the activation activates the joint DL and UL TCI state for each BWP of each of the multiple CCs.

18. The apparatus of claim 14, wherein the activation activates the joint DL and UL TCI state for an active BWP of each of the multiple CCs.

19. The apparatus of claim 18, wherein the active BWP is a downlink BWP or an uplink BWP.

20. The apparatus of claim 14, wherein the at least one processor and the memory are further configured to:
transmit a configuration of a CC list for cross-CC activation of the joint DL and UL TCI state.

21. The apparatus of claim 20, wherein the CC list comprises a dedicated CC list for the cross-CC activation of the joint DL and UL TCI state.

22. The apparatus of claim 20, wherein the CC list is for the cross-CC activation of a DL TCI state or an UL TCI state.

23. The apparatus of claim 14, wherein the at least one processor and the memory transmit the activation of the joint DL and UL TCI state in a message that indicates a joint TCI state identifier (ID) and an ID of one or more component in the joint TCI state ID.

24. The apparatus of claim 23, wherein the one or more component in the joint TCI state ID includes one or more of:
a reference signal ID,
an uplink power control parameter,
an uplink timing advance parameter,
a UE panel ID,
an antenna port ID, or
a beam group ID.

25. The apparatus of claim 14, wherein the at least one processor and the memory are further configured to transmit, to the UE, downlink control information (DCI) indicating an index of a TCI codepoint, the index corresponding to one of the activated joint DL and UL TCI states.

26. A method of wireless communication at a user equipment (UE), comprising:
receiving, from a base station, an activation of a joint downlink (DL) and uplink (UL) transmission configuration indicator (TCI) state for a component carrier (CC), the joint DL and UL TCI state indicating a common beam for communication in DL and UL; and
applying the joint DL and UL TCI state to multiple CCs in response to receiving the activation of the joint DL and UL TCI state for the CC,
the activation being configured to activate a subset of configured joint DL and UL TCI states, each activated joint DL and UL TCI state indicating the common beam for communication in DL and UL.

27. The method of claim 26, further comprising:
receiving a configuration of a CC list for cross-CC activation of the joint DL and UL TCI state, wherein the UE applies the joint DL and UL TCI state to each CC comprised in the CC list.

28. The method of claim 26, further comprising:
receiving, from the base station, downlink control information (DCI) indicating an index of a TCI codepoint, the index corresponding to one of the activated joint DL and UL TCI states.

29. A method for wireless communication at a base station, comprising:
configuring a component carrier (CC) list comprising multiple CCs; and
transmitting, to a user equipment (UE), an activation of a joint downlink (DL) and uplink (UL) transmission configuration indicator (TCI) state for a CC comprised in the CC list to activate the joint DL and UL TCI state for each of the multiple CCs comprised in the list, wherein the joint DL and UL TCI state indicates a common beam for communication in DL and UL,
the activation being configured to activate a subset of configured joint DL and UL TCI states, each activated joint DL and UL TCI state indicating the common beam for communication in DL and UL.

30. The method of claim 29, wherein the base station transmits the activation of the joint DL and UL TCI state in a message that indicates a joint TCI state identifier (ID) and an ID of one or more component in the joint TCI state ID.
